(19) United States
(12) Patent Application Publication
(10) Pub. No.: US 2004/0022916 A1
(43) Pub. Date: Feb. 5, 2004

(54) Particulate-based ingredient delivery system

(76) Inventors: William Alan Atwell, Champlin, MN (US); Dennis B. Gilbertson, Minnetonka, MN (US); Jodi Engleson, Minnetonka, MN (US); Jody Lee Mattsen, South Saint Paul, MN (US); Jessica Lee Earling, Minneapolis, MN (US)

Correspondence Address: Aleya R. Champlin, Esq., Fulbright & Jaworski L.L.P., Suite 4850, 225 South Sixth Street, Minneapolis, MN, 55402, US

(21) Appl. No.: 10/420,139

(22) Filed: Apr. 21, 2003

Related U.S. Application Data
(63) Continuation-in-part of application No. 09/746,556, filed on Dec. 22, 2000.

(51) Int. Cl. A21D 10/00

(52) U.S. Cl. 426/549

(57) ABSTRACT

A particulate ingredient delivery system for food products is described. The system is capable of providing to a food product a nutrient or other ingredients at desired levels without adversely affecting the quality of the food product. The system can be utilized to provide food products meeting specific nutrient-based FDA health claim labeling requirements.

### RELATED APPLICATIONS

This application is a Continuation-in-Part of U.S. application Ser. No. 09/746,556, filed on Dec. 22, 2000.

### BACKGROUND OF THE INVENTION

Commercial food manufacturers strive to deliver improved food products to the consumer to meet a wide variety of consumer preferences. One such consumer preference is the desire to increase the nutritional value of regularly consumed food products such as breads, rolls, buns and other bakery products. The desire for highly nutritive food products must also be balanced by the consumer's preference for organoleptically appealing food products. The commercial food manufacturer is faced with the challenge of providing highly nutritive food products, such as bakery products, which retain acceptable organoleptic properties such as taste, texture, and appearance, and especially those products that can retain the desired organoleptic properties during the shelf life of the food product.

The nutritional value of a food product, therefore, is something that the commercial food manufacturer would want to promote to the consumer through labeling, advertising, and the like. As with other aspects of food labeling, the U.S. Food and Drug Administration (FDA) has issued regulations regarding the health claims that can be made regarding a food product. Among these regulations are regulations that are specific to the level of nutrients delivered by the food product in order to support the claimed health benefit. In other words, in order for a food product to carry an FDA-approved health claim on the product label or other promotional materials, the food product must consistently deliver a nutrient or a combination of nutrients at defined levels per serving.

Bread is a dietary staple to which many nutritional ingredients have been added. Currently, there are commercially available whole grain breads, 9- and 12-grain breads, breads designed to deliver specific nutrients or supplements to meet specific dietary needs, and other similar breads. Although these breads contain nutritive ingredients, the level of a specific nutrient, such as soy protein or whole oat soluble fiber, provided per serving generally falls short of the levels required by the FDA regulations. This is because the high level of nutrients required for making an FDA health claim on a product typically have an adverse effect on the quality of the bread, particularly on the specific volume and texture of the bread.

There is a commercial bread product available on which an FDA health claim has been made regarding the whole oat soluble fiber content. However, this product relies on a chemical fortification system in which a processed oat bran fiber concentrate is used to deliver the whole oat soluble fiber level needed to meet the FDA requirement. The oat bran concentrate is made by chemically processing and significantly altering the oat bran to reduce its impact on the bread quality. The oat bran concentrate, therefore, is a chemical fortification system, rather than a “natural” or minimally processed nutrient.

In addition, many whole wheat breads meet the FDA health claim requirement regarding whole grain content. Whole wheat contains wheat gluten, and therefore tends to have a less adverse effect on the quality of the bread, particularly on the specific volume and texture of the bread, than non-wheat ingredients. Although these types of products meet the requirements regarding their total whole grain content, they are not directed to providing a specific type of nutrient, such as soy protein or whole oat soluble fiber, at the level required to make an FDA health claim.

A need exists among commercial bakery product manufacturers to provide to the consumer a bakery product which delivers high ingredient levels, particularly nutrient levels sufficient to make an FDA health claim, that has good organoleptic properties, such as volume and texture, and that uses ingredients that are minimally processed and that retain many of their natural properties.

### SUMMARY OF THE INVENTION

The present invention is directed to an ingredient delivery system for a bakery product, wherein the system is capable of providing a certain level of an ingredient in a bakery product. The system comprises a particulate ingredient, and the bakery product made with the system has a specific volume at least equal to a specific volume of a control bakery product made without the particulate ingredient, but with a same ingredient in flour form and providing the same level of the ingredient in the bakery product.

The present invention is further directed to a bakery product having a particulate ingredient delivery system, the system providing a level of the particulate ingredient in the bakery product, wherein the specific volume of the bakery product is at least equal to the specific volume of a control bakery product comprising the same level of the ingredient in flour form.

The present invention is also directed to a method of making a particulate-containing dough, comprising the steps of providing a particulate ingredient, and combining the particulate ingredient with wheat flour, yeast, salt and water to form a dough having a gluten matrix, wherein the particulate ingredient does not substantially interfere with the gluten matrix.

### DESCRIPTION OF THE DRAWINGS

FIGS. 1A and 1B are texture analysis graphs of a control product, and a product made according to the present invention, at Day 1 after baking and Day 6 after baking, with elements numbered 1-6 representing Formulas 1-6, respectively, of Example 1.

FIG. 2A is an end plan view of the products made in Example 1, with elements numbered 1-6 representing products made from Formulas 1-6, respectively, of Example 1.

FIG. 2B is a partial side plan view of the products made in Example 1, with elements numbered 1-6 representing products made from Formulas 1-6, respectively, of Example 1.

FIG. 2C is a cross-sectional view of the products made in Example 1, taken along line C-C′ of FIG. 2B, with elements numbered 1-6 representing products made from Formulas 1-6, respectively, of Example 1.

FIG. 3A is an end plan view of the products made in Example 2, with elements numbered 1-6 representing products made from Formulas 1-6, respectively, of Example 2.

FIG. 3B is a side plan view of the products made in Example 2, with elements numbered 1-6 representing products made from Formulas 1-6, respectively, of Example 2.

FIG. 3C is a cross-sectional view of the products made in Example 2, taken along lines C-C′ of FIG. 3B, with elements numbered 1-6 representing products made from Formulas 1-6, respectively, of Example 2.

FIG. 4A is an end plan view of the products made in Example 3, with elements numbered 1-6 representing products made from Formulas 1-6, respectively, of Example 3.

FIG. 4B is a side plan view of the products made in Example 3, with elements numbered 1-6 representing products made from Formulas 1-6, respectively, of Example 3.

FIG. 4C is a cross-sectional view of the products made in Example 3, taken along line C-C′ of FIG. 4B, with elements numbered 1-6 representing products made from Formulas 1-6, respectively, of Example 3.

FIG. 5A is an end plan view of the products made in Example 4, with elements numbered 1-6 representing products made from Formulas 1-6, respectively, of Example 4.

FIG. 5B is a side plan view of the products made in Example 4, with elements numbered 1-6 representing products made from Formulas 1-6, respectively, of Example 4.

FIG. 5C is a cross-sectional view of the products made in Example 4, taken along line C-C′ of FIG. 5B, with elements numbered 1-6 representing products made from Formulas 1-6, respectively, of Example 4.

FIG. 6A is a plot of average standard volume vs. percent oat grits for oat grit particulate containing products at different moisture levels.

FIG. 6B is a plot of average specific volume vs. percent corn grits for corn grit particulate-containing products at different moisture levels.

FIG. 6C is a plot of average specific volume vs. percent coffee grits for coffee grit particulate-containing products at different moisture levels.

FIG. 7A is a plot of average specific volume vs. average particle size for soy grit particulate-containing products.

FIG. 7B is a plot of average specific volume vs. average particle size for corn grit particulate-containing products.

FIG. 8 is a plot of particulate moisture content vs. point of operation for several types of particulate ingredients.

FIGS. 9A-D are a series of farinographs demonstrating the characteristics of dough containing various particulates.

FIG. 10 is a chart showing the dilution of soy protein concentration as ingredients are added to a dough.

FIG. 11 is a chart showing the dilution of whole oat soluble fiber concentration as ingredients are added to a dough.

### DETAILED DESCRIPTION

The present invention is directed to the unexpected discovery that by selecting ingredient particle sizes based on certain parameters, high levels of nutrients or other ingredients can be added to a flour-based dough without adversely affecting the specific volume and texture of the final baked product resulting from the dough. The levels of nutrients that can be added meet or even exceed the levels defined by the FDA for making a health claim on the food product.

Commercial Bread and Bakery Product Manufacturing

The properties of bread and other bakery products are predominantly determined by the properties of the dough. The dough properties, in turn, are determined by the dough ingredients and by how the dough is processed. The most basic dough ingredients are wheat flour, water, salt, and a leavening system, such as yeast and chemical leavening agents, or a combination of both types of leavening agents.

Upon mixing water with the flour and the leavening, the flour particles become hydrated, and the shear forces applied by mixing cause wheat gluten protein fibrils from the flour particles to interact with each other and ultimately form a continuous gluten matrix. Gluten is the primary protein complex found in wheat flour.

As the dough is mixed, air is incorporated in the dough, creating air cells throughout the dough. When carbon dioxide gas is generated by the leavening reaction in the dough, the carbon dioxide first goes into solution. As the water in the dough becomes saturated with carbon dioxide, carbon dioxide being generated by the leavening migrates into the air cells in the dough. The number and stability of the air cells in the dough is determined by the quality of the gluten matrix.

A well-developed wheat gluten matrix results in a dough that can retain the carbon dioxide generated by the leavening system, and therefore deliver the desired specific volume in the final baked product.

Adding non-glutenaceous ingredients to the dough intereferes with the ability of the gluten to form a continuous matrix during mixing. As used herein, the term “non-glutenaceous” shall refer to ingredients that do not contribute a significant amount of wheat gluten to the product. The non-glutenaceous ingredients may compete for the moisture in the dough, thereby hindering the formation of the gluten matrix. In addition, the non-glutenaceous ingredients may occupy space in the dough and physically limit the gluten-gluten interactions required to form the gluten matrix. Furthermore, the non-glutenaceous ingredients may serve as air cell nucleation sites and may cause large air pockets to form in the dough. Gas generated by the leavening action will preferentially migrate to the air pockets rather than remaining distributed in the smaller air cells that are more evenly dispersed through the dough, creating an undesirable texture in the final bakery product. Therefore, the advantages of adding non-glutenaceous ingredients to the bread, such as non-wheat based nutrients, must be balanced with the deleterious effects such ingredients may have on the gluten matrix, the overall dough structure, and the resulting baked product quality.

FDA-Approved Health Claims

Starting in 1994, the FDA has been issuing regulations regarding health claims that may be made on food labels if the food product meets certain requirements. These regulations are contained in 21 Code of Federal Regulations, Section 101 (21 C.F.R. §101 et. seq.). Certain portions of these regulations are set forth below.

21 C.F.R. §101.77 is directed to health claims on fruits, vegetables and grain products that contain fiber, particularly soluble fiber, and the risk of coronary heart disease. One of the food requirements is that the product delivers at least 0.6 g of soluble fiber, without fortification, per 50 g serving.

21 C.F.R. §101.81 is directed to health claims on soluble fiber and the risk of coronary heart disease. One of the food requirements is that the product delivers at least 0.75 g of whole whole oat soluble fiber per 50 g serving, or at least 1.7 g of psyllium husk soluble fiber per 50 g serving.

21 C.F.R. §101.82 is directed to health claims on soy protein content and the risk of coronary heart disease. One of the food requirements is that the product delivers at least 6.25 g of soy protein per 50 g serving of the food product.

In addition to the claims approved in the FDA Regulations, the FDA has also authorized certain health claims based on authoritative statements by other federal scientific bodies. Included in these claims is a claim on whole grain foods and the risk of heart disease and certain cancers (FDA Docket No. 99P-2209). One of the food requirements is that the product contain at least 51 percent or more of whole grain ingredients per reference amount (serving), and a dietary fiber content of at least 3.0 g/55 g serving, or 2.8 g/50 g serving, or 2.5 g/45 g serving, or 1.7 g/35 g serving.

In order to make the foregoing health claims on a food product, the food product must also meet the nutritional requirements for low fat content (less than 3 g of fat per 50 g of product), low saturated fat content (the saturated fat content of the 3 g of fat must be less than 1 g, and the saturated fat content must contribute 15% or less of the calories per serving), and low cholesterol content (the cholesterol present in the 3 g of fat must be less than 20 mg.) The food product must also contain less than 480 mg of sodium per 50 g serving of the food product.

Commercial Bakery Products Meeting FDA Health Claim Requirements

As noted previously, until the present invention, it has not been possible to provide commercial bakery products that meet the requirements of FDA health claims for specific nutrients without using chemical fortification methods, and without adversely affecting the quality of the bakery product. The present invention is directed to the unexpected discovery that particulate materials selected based on certain characteristics can be incorporated into bakery products at the desired levels without adversely affecting the quality of the bakery product.

The quality of a bakery product can be defined by the specific volume of the bakery product. In general, if the specific volume is above a certain level, the bakery product will have the desired texture and appearance. However, there are instances in which a specific volume may be too high, resulting in poor handling characteristics. The commercial food manufacturer strives to consistently deliver bakery products that achieve the desired specific volume to provide an organoleptically pleasing product that can withstand normal handling conditions.

As used herein, the term “bakery product” refers to any product that utilizes a gluten matrix to provide the desired product characteristics, including, but not limited to, breads, rolls, buns, bagels, pretzels, pizza or similar crusts, tortillas, pita bread, foccacia, English muffins, donuts and “cakey” brownies, which are baked or otherwise processed with heat to set the finished product structure.

It has been found that specific volumes around 3.0 cc/g or higher result in the desired bakery product characteristics. Generally, the specific volume of bakery products of the present invention containing particulate nutrients or other ingredients is approximately equal to or greater than the specific volume of bakery products containing the same level of nutrients or other ingredients in non-particulate form (hereinafter referred to as “control” bakery products, unless specified otherwise.) Preferably, the specific volume of a product made with the particulate ingredient delivery system of the present invention will be greater than about 1.2 times the specific volume of a control bakery product, and more preferably will be greater than 1.3 times the specific volume of a control product.

Particulate Ingredients

It has been unexpectedly discovered that by optimizing certain particulate characteristics, very high levels of non-glutenaceous particulates can be incorporated into the dough without substantially adversely affecting the gluten matrix of the dough or the specific volume of the final bakery product. These particulates are preferably selected to provide a high level of nutrients or other ingredients to the final bakery product. More preferably, these particulates deliver a level of nutrients to the final product in an amount at least sufficient to meet an FDA health claim requirement. As used herein, the term “particle” and “particulate” will be used interchangeably, and shall refer to ingredients that are incorporated into the dough and are therefore distributed throughout the crumb and crust of the baked product, as opposed to simply being sprinkled on the surface of the product.

The particulates are preferably selected to be of a size that is large enough not to disintegreate readily upon contact with water under mixing conditions, but not so large as to create large air cells around the particulate. If the particulates hydrate readily and are incorporated into the dough, similar to flour, then the particulates will interfere with the formation of the gluten matrix and will adversely affect the final bakery product volume. On the other hand, if the particulates are large, they will act as air cell nucleation sites and will create large air cells in the dough. This will result in an undesirable final bakery product crumb structure and volume.

The average size of the particulate is macromolecular, or visible to the naked human eye. Preferably, the average particle size is selected to be larger than the average particle size of wheat flour, or greater than about 100 μm in diameter. More preferably, the average particle size is between about 150 μm to about 7000 μm in diameter, and particularly preferred is an average particle size ranging from about 800 μm to about 5000 μm in diameter.

In addition to the average size of the particle, the ability of the particle to hydrate also determines the ability to incorporate large amounts of the particulate into the dough. If the particle does not readily hydrate and maintains much of its integrity during the dough mixing process, a smaller particle size may be used without adversely affecting the dough and baked product properties. Generally, the particulates useful in the present invention are integrated into the dough at a level less than about 50%, preferably less than about 35%, and more preferably less than about 20%. In other words, the particle has an integrity of greater than about 50%, preferably greater than about 65% and more preferably greater than about 80% in the bakery product.

To determine the particulate integration level, the amount of particulate material added to the dough is measured on a dry basis, and compared to the amount of particulate on a dry basis extractable from the product resulting from baking the dough. If the difference is less than about 50%, then the particulate is suitable for use in the present invention to deliver nutrients or other ingredients to the bakery product without adversely affecting the specific volume of the product.

Another particulate characteristic that determines the size and amount of particulate that can be added to the dough is particle surface texture. In general, smoother particles do not serve as air cell nucleation sites as readily as particles with irregular surfaces. The irregularities on the particle surface provide small pockets of air in the dough that create air cells in contact with or adjacent to the particulate. As carbon dioxide gas enters into these air cells, the cells grow and agglomerate, creating a large cell around or adjacent to the particulate. If these cells are large enough, they may increase the diffusion of gas through the dough and may even cause the dough to collapse, resulting in poor baked product quality.

It is preferable, therefore, to use particulates having a smooth particle surface in the present invention. This is especially true for large particles, such as those having an average particle size of between about 4000 μm to 7000 μm. Particulates can be made from any ingredient that either naturally forms smooth particulates, or by using methods that result in smooth particulates. Whole soybeans are an example of a material having a smooth particle surface, as compared to whole corn kernels, which have an irregular surface.

As described herein, the particulates in accordance with the present invention can include any ingredient suitable for use in a food product. This category of ingredients includes those ingredients that provide specific nutrients or other functions to the food product. Examples of ingredients include, but are not limited to, grains, fruits, vegetables, vitamins, seeds, nuts, candy, minerals, antioxidants, chocolate, wild rice, oilseeds, spices, fiber, legumes, dairy products or ingredients, cheese, calcium, dried meats, bouillon, medications or drugs, dietary or health supplements, beta glucans, arabinoxylans, inulin, peanuts, encapsulated liquids or gels, and the like.

Other Dough Ingredients

In addition to the particulate ingredient, the products in accordance with the present invention may also include the same ingredient in flour form. As used herein, the expression “same ingredient in flour form” shall include a flour made from the same starting material as the particulate ingredient, with the flour particles having an average particle size of 100 μm or less. For example, in a soy grit particulate containing formula, a certain level of soy flour may also be included, in a oat grit particulate containing formula, a certain level of oat flour may also be included, etc.

The wheat flour used in accordance with the present invention is preferably a high protein wheat flour, containing about 14% protein by total weight of the flour. The flour is present in doughs made in accordance with the present invention at levels ranging from about 30 wt-% to about 50 wt-%. As used herein, the expression “wt-%” shall refer to percent by weight of the formula on a dry basis, unless specified otherwise.

In addition to the high protein flour, wheat gluten, preferably vital wheat gluten, may be added to the formula to increase the gluten content of the dough. If wheat gluten is added, it is preferably added in an amount ranging from 0 wt-% to about 20 wt-%, more preferably in the range of about 5 wt-% to 15 wt-%. In one preferred embodiment, vital wheat gluten is present at a level of about 6 wt-%.

The products in accordance with the present invention may optionally include a fat component. The fat component serves to plasticize the dough, and to soften the texture of the final baked product. The fat component also helps to improve the specific volume of the final product. The fat component can be in either liquid or solid form. Fat can be present in bakery products at levels ranging from about 0 wt-% to about 20 wt-% Preferably, the fat is present in products of the present invention at levels ranging from 0 wt-% to about 5 wt-%, more preferably between about 1 wt-% to about 3 wt-%. In one preferred embodiment, fat is present at a level of about 2.5 wt-%.

Examples of fats that may be suitable for use in the present invention, include, but are not limited to soybean oil, corn oil, canola oil, cottonseed oil, olive oil, tropical oils, other vegetable oils, and animal fats, such as butter, tallow and lard. Fat substitutes may also be used.

In order to meet the requirements of FDA health claims, bakery products made in accordance with the present invention must contain less than 3 g of fat per 50 g serving of the bakery product, and of the 3 g of fat, less than 1 g of fat may be saturated fat. In addition, the saturated fat must provide less than 15% of the total calories of the 50 g serving of the product. Finally, the 3 g of fat must provide less than 20 mg of cholesterol per 50 g serving of the product.

Other conventional dough ingredients can be included, such as dough conditioners, emulsifiers, salt, flavorings, and the like. If such ingredients are used, they are generally present in amounts sufficient to have the desired effect on the dough and final product properties, without adversely affecting the processability of the dough or the organoleptic properties of the final product. Preferably, these ingredients are present in amounts ranging from about 0 wt-% to about 5 wt-% of each ingredient, more preferably less than about 3 wt-% of each ingredient.

If sodium chloride or other sodium-containing flavoring agents are used to make the bakery products of the present invention, in order to meet the requirements of an FDA health claim, the product must contain less than 480 mg of sodium per 50 g serving of the product.

A common flavoring agent added to doughs is a sweetening agent. The sweetening agent imparts a desirable flavor and color to the baked product, and may be useful when the yeast is generating carbon dioxide. Both natural and artificial sweeteners may be used, including, but not limited to, sugar (sucrose), sucralose, aspartame, and the like.

Yeast is added to the dough ingredients at a level sufficient to provide the desired carbon dioxide level in the dough during proofing, and the desired taste and texture to the final baked product. Preferably, fresh bakers yeast is used. Generally, yeast is present in amounts ranging from 1 wt-% to about 10 wt-%, preferably from about 3 wt-% to about 5 wt-% of the dough formula. In one preferred embodiment, yeast is present at a level of about 4 wt-% of the dough formula.

Although the standard of identity for bread requires the use of yeast as the leavening agent, many other products utilize chemical leavening agents, or a combination of yeast and chemical leavening agents. Products made in accordance with the present invention that utilize chemical leavening agents or combinations of leavening agents will typically include such leavening agents at levels sufficient to provide the desired level of carbon dioxide in the dough to result in the suitable final product characteristics.

Water is added to the dough ingredients in accordance with the present invention at levels ranging from about 20 wt-% to about 40 wt-%. Those skilled in the art will understand that the amount of water added to the dough ingredients is a complex variable, depending on the type and amount of ingredients used, the environmental conditions, the mixing conditions, and the like. The water content of the dough is preferably optimized based on dough handling properties and desired final product characteristics.

Specific embodiments of the present invention are described below. Each ingredient type listed is used consistently throughout the Examples unless specified otherwise. Although these embodiments fully disclose and enable the practice of the present invention, they are not intended to limit the scope of the invention, which is defined by claims appended hereto.

### EXAMPLE I

### Soy Protein-Containing Bakery Product

A bread product containing a soy protein level sufficient to meet the FDA soy protein health claim requirement was made by adding soy flour and/or soy grits to the dough. It was surprisingly discovered that by adding soy grits to the dough, significant improvements to the dough structure and the final baked product were achieved as compared to using soy flour as the exclusive source of soy protein in the dough. This is quite unexpected and surprising, since the soy grit particulates are substantially larger than the average particle size of soy flour, and would have been expected to significantly interfere with the gluten matrix formation during mixing.

Six formulas were used, each with a different level of soy flour and soy grits. All ingredient levels are shown as percent by weight (wt-%), unless indicated otherwise.

TABLE 1
Soy Ingredient Combinations

| | Formula | Formula | Formula | Formula | Formula | Formula |
|---|---|---|---|---|---|---|
| Ingredient | 1 | 2 | 3 | 4 | 5 | 6 |
| Soy Flour¹ | 42.00 | 31.00 | 21.00 | 16.80 | 11.00 | 0.00 |
| Soy Grits² | 0.00 | 11.00 | 21.00 | 25.20 | 31.00 | 42.00 |
| Ratio of Soy | 1:0 | 2.8:1 | 1:1 | 1:1.5 | 1:2.8 | 0:1 |
| Flour:Soy Grits | | | | | | |
| Percent Ratio | 100:0 | 74:26 | 50:50 | 40:60 | 26:74 | 0:100 |

¹Cargill 200/70 + 15% Relecithinated Soy Flour, Cargill, Inc. MN
²ADM Nutrisoy ® Defatted Soy Grits, 90% min through #8-mesh, 1% max through #30-mesh, Archer Daniels Midland Co., IL

To make the dough, the soy ingredients were combined with the following base formula, along with 90 grams of fresh yeast and 1275 grams of 60° F. water, to result in a dough having a moisture content of about 40.6%

TABLE 2
Base Formula (2268 g base formula)

| Ingredient | Weight Percent |
|---|---|
| Flour¹ | 43.45 |
| Soy Ingredient (see Table 1) | 42.00 |
| Vital Wheat Gluten² | 6.00 |
| Shortening³ | 2.50 |
| Corn starch⁴ | 1.50 |
| Salt | 2.00 |
| Mono- and Diglyceride Emulsifiers⁵ | 0.80 |
| Dough Conditioner⁶ | 0.80 |
| Sodium Stearoyl Lactylate⁷ | 0.80 |
| Aspartame⁸ | 0.15 |

¹Cargill “Progressive Baker High Gluten Hummer” Flour, Cargill Inc., MN
²ADM Ogilvie Provim ESP ® Vital Wheat Gluten, Archer Daniels Midland Company, IL
³Cargill Soybean Salad Oil (soybean oil with citric acid as preservative), Cargill, Inc., MN
⁴Cargill Powdered Waxy Starch 2850, Cargill, Inc., MN
⁵ADM Arkady Panalite ® 50 SV K emulsifier, Archer Daniels Midland, IL
⁶Puratos S-500 Red Dough Conditioner, Puratos, NJ
⁷ADM Arkady Paniplex ® S K sodium stearoyl lactylate, Archer Daniels Midland, IL
⁸NutraSweet ® Custom Encapsulated 20 ™, NutraSweet Company, IL

The ingredients were mixed in a Hobart C-100 mixer for 1 minute on the low setting, then 10 minutes on the medium setting. 200 g portions of the dough were made and rounded, then allowed to rest for 10 minutes. The dough of Formula 1 which contained only soy flour as the soy ingredient was the Control dough formula in this example, and was noticeably quite stiff and difficult to handle compared to the soy grit-containing formulas. It is believed that this is due to the water absorption properties of soy flour, which absorbs more water and becomes more integrated into the dough than soy grits.

To simulate commercial breadmaking, a pre-weighed, rounded dough portion was sheeted to 6 mm in thickness, rolled into a cylinder, and then placed in a pup loaf pan and proofed to 1 inch above the top of the pan in a proof box at 105° F. and 95% relative humidity. The dough was then baked in the pan for 16 minutes at 400° F. As discussed previously, each formula resulted in a baked product that met the requirements for an FDA health claim based on soy protein content, providing at least 6.25 g of soy protein per 50 g serving of product.

The specific volume of bread made from each formula was measured using a conventional rapeseed displacement method. The results are summarized in Table 3.

TABLE 3
Average Specific Volume

| Formula | Average Specific Volume (cc/g) |
|---|---|
| 1 | 2.63 |
| 2 | 3.15 |
| 3 | 3.76 |
| 4 | 3.88 |
| 5 | 3.91 |
| 6 | 3.30 |

As can be seen from Table 3, there is a significant increase in specific volume as the soy grit concentration increases in the dough up to about 31% soy grits by weight of the dry ingredients. Above the 31% soy grits level, the specific volume drops off somewhat, but is still greater than the specific volume of Control Formula 1. The decrease in the specific volume at levels greater than 31% is believed to be due to the combination of the high level of soy grits and the free water, which may interfere with the development of the gluten matrix.

The particulate integrity of the soy grits was measured by removing the intact soy grit particles from the baked product and weighing the particles. The difference between the dry weight of the soy grit particles after baking and the dry amount of soy grits added to the dough ranged from about 0% to about 35%, representing a particulate integrity of between about 65% to about 100%.

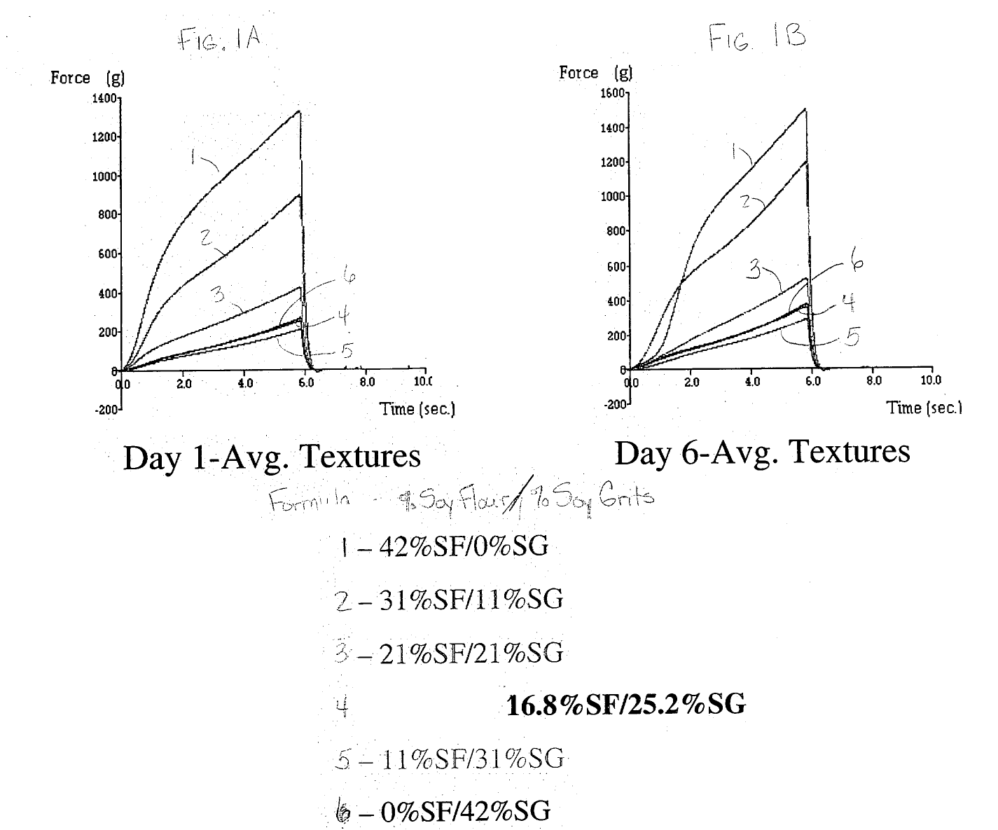

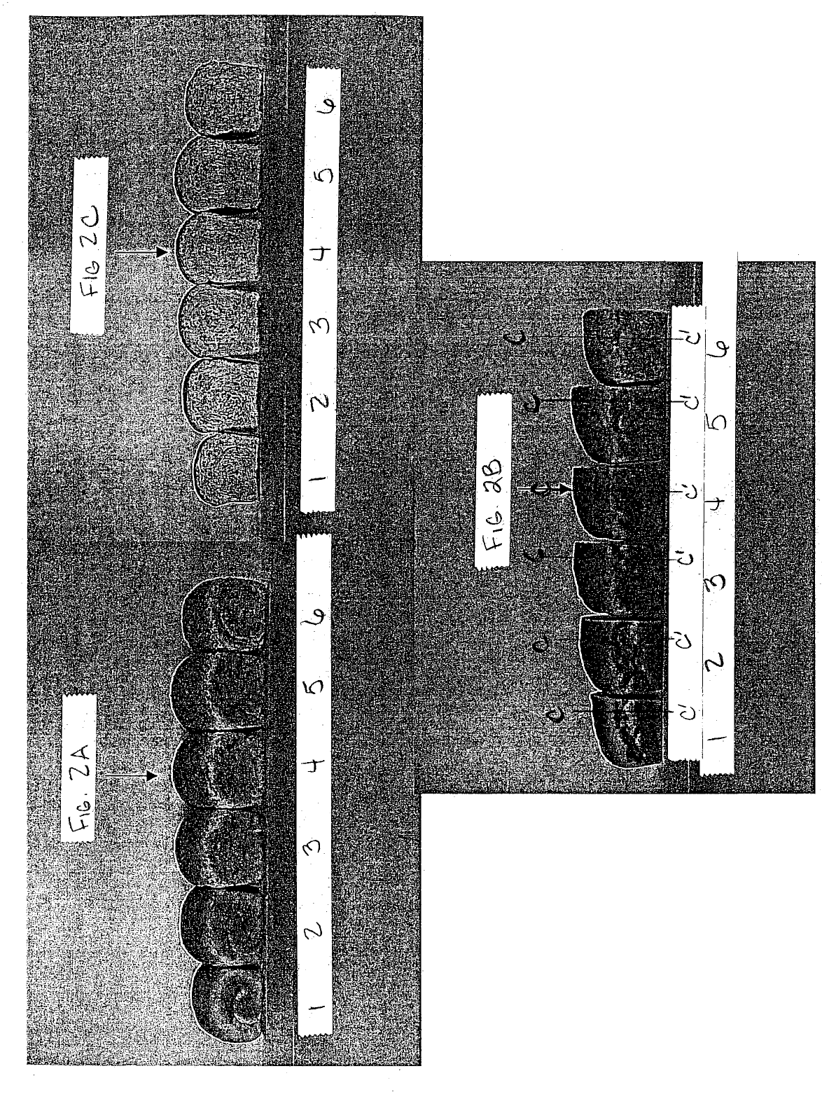

The texture of the bread product made from each formula was measured as a function of time, to determine the shelf-life properties of each formula. The texture analysis was done using a TA-XT 2I Texture Analyzer (Texture Technologies Corp., NY). The texture was analyzed using a conventional compression test run at a rate of 1.7 mm/sec to a distance of 10 mm. The analysis was performed one day (Day 1) after the product was baked, and then again at 6 days (Day 6) after the product was baked. The results are shown in FIGS. 1A and 1B. As can be seen in FIGS. 1A and 1B, Control Formula 1 resulted in the most firm texture on both Day 1 and Day 6, with the firmness decreasing as the level of soy grits in the formula increased. The presence of soy grit particulates in the dough, therefore, results in a baked product with a desirable softer texture and a slower firming rate when compared to Control Formula 1.

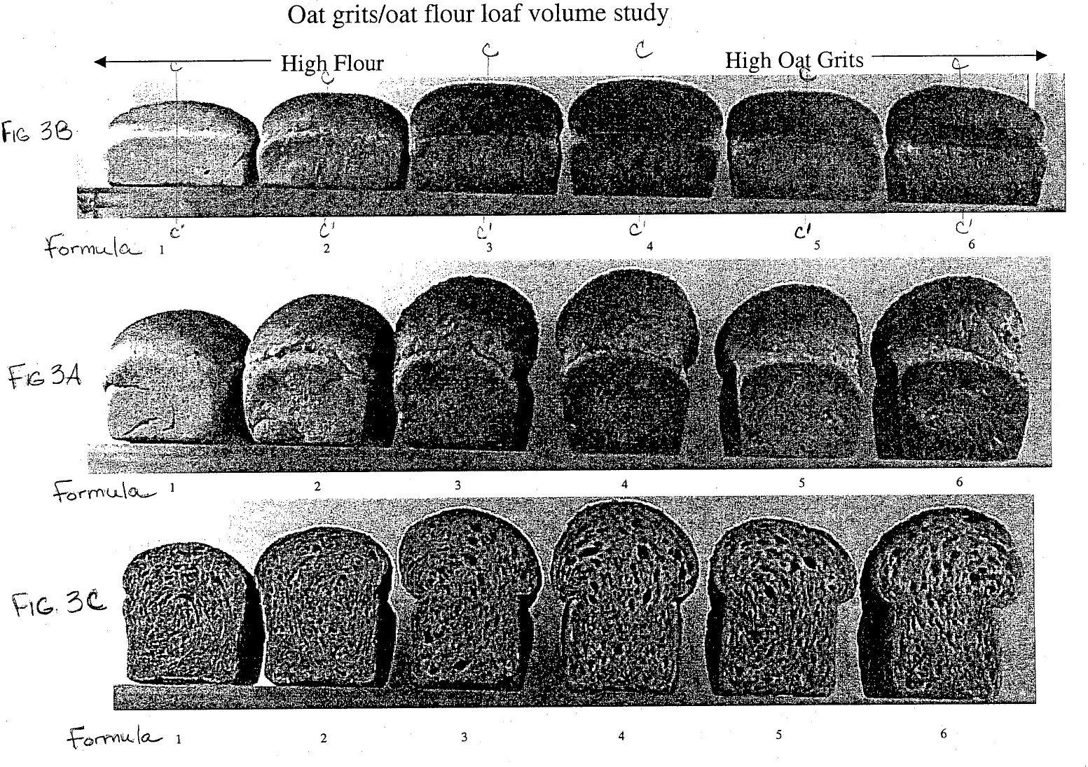

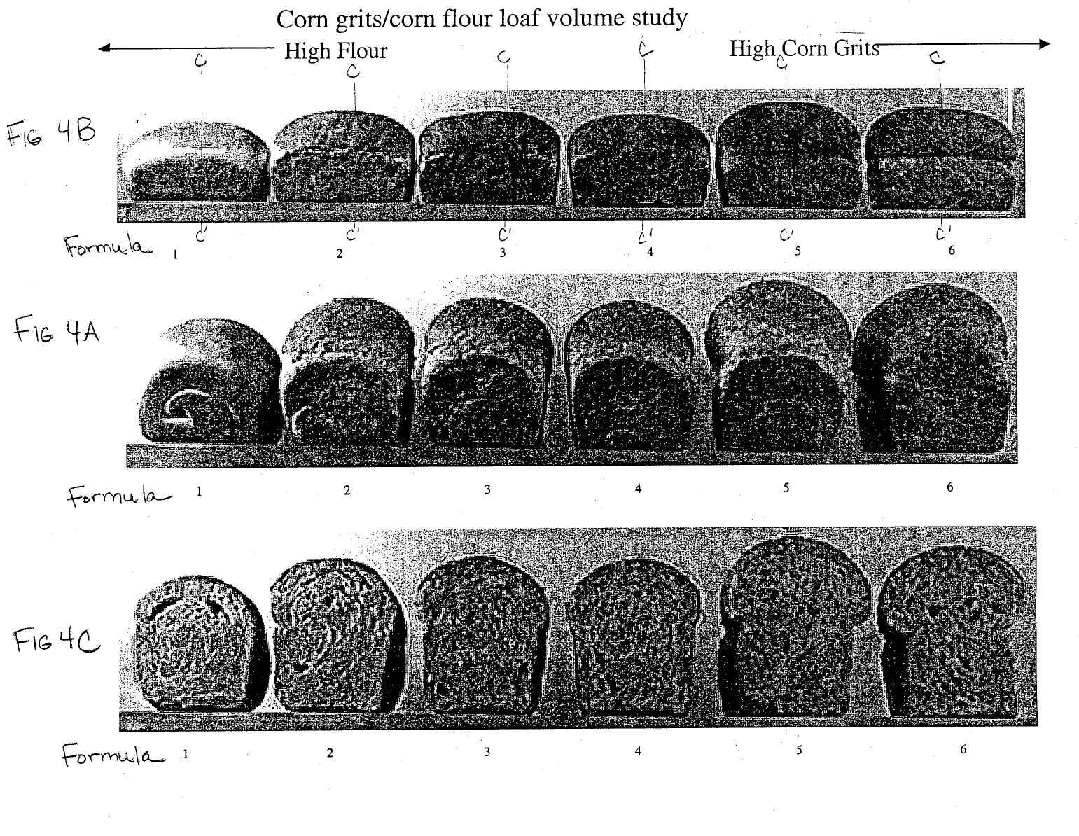

FIGS. 2A-C show images of the bread products made using Formulas 1-6. As can be seen from these figures, as the concentration of soy grit particulates in the dough formula increased, the specific volume of the baked product increased as compared to a control formula containing only soy flour as the soy ingredient (Formula 1). In this embodiment of the invention, the specific volume of the particulate-containing bakery product ranged from about 1.2 to about 1.5 times the specific volume of the control product.

A sensory panel test was conducted to evaluate products made from Formulas 1-6 to determine the effect of varying the ratio of soy flour to soy grits on the overall liking of the soy-containing bread. Using a 9-point hedonic scale, panelists were instructed to rate the soy-containing bread products with a score of 1 being “dislike extremely” and a score of 9 being “like extremely”. The results are summarized in Table 4.

TABLE 4
Sensory Panel Scores

| Formula | Least Square Means Score |
|---|---|
| 1 | 5.05 |
| 2 | 6.08 |
| 3 | 6.64 |
| 4 | 6.83 |
| 5 | 7.10 |
| 6 | 7.18 |

Significant differences were found between the products. Overall, the panelists' liking was directly correlated to the amount of soy grits present in the bread sample.

In addition to meeting the soy protein content requirement of the FDA soy protein health claim, a product made in accordance with this embodiment preferably also meets the other requirements of the FDA health claim, namely, that the product has a low fat content, a low saturated fat content, and a low cholesterol content, and also meets the sodium content requirement.

In this embodiment of the invention, therefore, a particulate nutrient delivery system comprising soy grits preferably at a level of about 11% by weight of dry ingredients or greater demonstrated desirable dough handling and baked product properties, including meeting the FDA health claim requirement and having a specific volume of at least about 1.2 times the specific volume of the control product, and a particle integrity level of greater than 65%.

### EXAMPLE II

### Whole Oat Soluble Fiber-Containing Bakery Product

A bread product containing a whole oat soluble fiber level sufficient to meet the FDA soluble fiber health claim requirement was made by adding oat flour and/or oat grits to the dough. It was surprisingly discovered that by adding oat grits to the dough, significant improvements to the dough structure and the final baked product were achieved as compared to using oat flour as the exclusive source of whole oat soluble fiber in the dough. This is unexpected since the oat grit particles are larger than the oat flour particles, and would have been expected to significantly interfere with the gluten matrix formation during mixing. This is especially surprising because a commercially available bread product meeting the FDA soluble fiber health claim requirement utilizes a processed oat bran fiber concentrate to achieve the fiber level, rather than oat grit particulates, presumably to minimize the adverse effects that larger oat-based particulates would be expected to have on the gluten matrix.

Six formulas were used, each with a different level of oat flour and oat grits. All ingredient levels are shown as percent by weight (wt-%), unless indicated otherwise.

TABLE 5
Oat Ingredient Combinations

| | Formula | Formula | Formula | Formula | Formula | Formula |
|---|---|---|---|---|---|---|
| Ingredient | 1 | 2 | 3 | 4 | 5 | 6 |
| Oat Flour¹ | 50.00 | 36.84 | 25.00 | 20.00 | 13.16 | 0.00 |
| Oat Grits² | 0.00 | 13.16 | 25.00 | 30.00 | 36.84 | 50.00 |
| Ratio of Oat | 1:0 | 2.8:1 | 1:1 | 1:1.5 | 1:2.8 | 0:1 |
| Flour:Oat Grits | | | | | | |
| Percent Ratio | 100:0 | 76:24 | 50:50 | 40:60 | 24:76 | 0:100 |

¹Whole Oat Flour #50, Grain Millers (Iowa), Inc., IA
²“No Soak” Steel Cuts, Grain Millers (Iowa), Inc., IA

To make the dough, the oat ingredients were combined with the following base formula, along with 50 grams of fresh yeast and 1003.42 grams of 40° F. water, to result in a dough with a moisture level of about 39.9 wt-%.

TABLE 6
Base Formula (1746 g base formula)

| Ingredient | Weight Percent |
|---|---|
| Flour | 31.81 |
| Oat Ingredient (see Table 5) | 50.00 |
| Vital Wheat Gluten | 8.59 |
| Shortening¹ | 2.43 |
| Sugar | 4.07 |
| Salt | 2.03 |
| Dough Conditioner | 1.15 |

¹Master Chef ™ All Purpose Shortening, Cargill, Inc., MN

The ingredients were mixed in a Hobart C-100 mixer for 1 minute on the low setting, then 10 minutes on the medium setting. 220 g portions of the dough were made and rounded, then allowed to rest for 10 minutes. The dough of Formula 1 which contained only oat flour as the oat ingredient was the Control dough formula in this example, and was noticeably quite stiff and difficult to handle compared to the oat grit-containing formulas. It is believed that this is due to the water absorption properties of oat flour, which absorbs more water and becomes more integrated into the dough than oat grits.

To simulate commercial breadmaking, a pre-weighed, rounded dough portion was sheeted to 6 mm in thickness, rolled into a cylinder, and then placed in a pup loaf pan and proofed to 1 inch above the top of the pan in a proof box at 105° F. and 95% relative humidity. The dough was then baked in the pan for 16 minutes at 400° F. As discussed previously, each formula resulted in a baked product that met the requirements for an FDA soluble fiber health claim based on whole oat soluble fiber content, providing at least 0.75 g of whole oat soluble fiber per 50 g serving of product.

The specific volume of bread made from each formula was measured using a conventional rapeseed displacement method. The results are summarized in 7.

TABLE 7
Average Specific Volume

| Formula | Average Specific Volume (cc/g) |
|---|---|
| 1 | 3.14 |
| 2 | 3.73 |
| 3 | 4.41 |
| 4 | 4.69 |
| 5 | 4.44 |
| 6 | 4.61 |

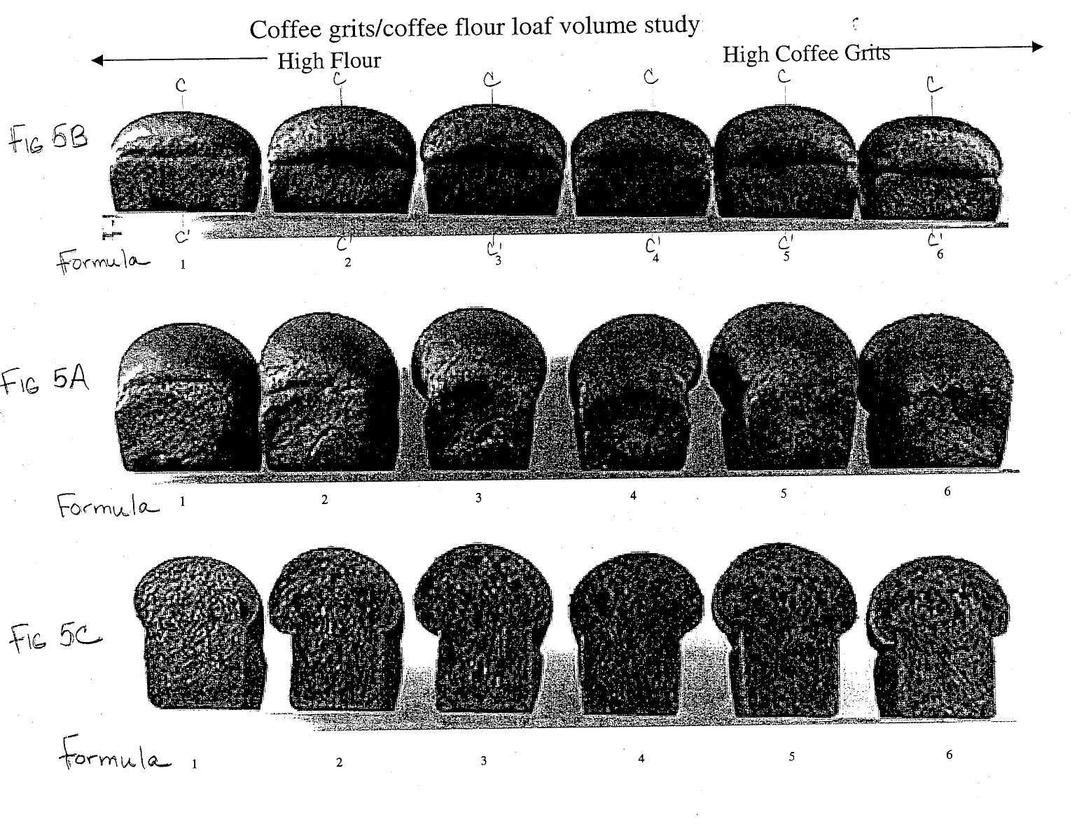

As can be seen from Table 7, there is a significant increase in specific volume compared to the control product as the oat grit concentration was increased in the dough. Similar to Example 1, as the oat grit concentration increased above about 30 wt-% of the base formula, the specific volumes began to decrease slightly possibly due to the interactions between the oat grit particulates and free water. However, even at oat grit levels above 30 wt-%, the specific volume of the baked products was greater than that of the control product. In this embodiment, the products made in accordance with the present invention had specific volumes ranging from about 1.2 to about 1.5 times the specific volume of the control product. FIGS. 3A-C show side, front and cross-sectional views of bread products made from Formulas 1-6 to demonstrate the improvement of specific volume as oat grits are added to the formula.

The particulate integrity of the oat grits was measured by removing the intact oat grit particles from the baked product and weighing the particles. The difference between the dry weight of the oat grit particles after baking and the dry amount of oat grits added to the dough was about 35%, indicating that about 65% of the oat grits had maintained their integrity throughout the breadmaking process.

In addition to meeting the whole oat soluble fiber content requirement of the FDA-approved health claim on soluble fiber, a product made in accordance with this embodiment of the invention preferably also meets the other requirements to meet the FDA health claim. These requirements include that a 50 g serving be low in fat, saturated fat, and cholesterol, and meet the requirement for sodium content.

This embodiment of the present invention demonstrates the unexpected finding that by optimizing particulate characteristics, large amounts of particulates, up to 50 wt-% on a dry basis, can be added to a dough formulation to meet an FDA health claim requirement without adverse effects on the specific volume of the corresponding baked product. In this embodiment, the oat grit particulate size was selected to preferably be about 1800 μm in diameter, but can range from about 1000 μm to about 5000 μm.

Although the foregoing examples have focused on the soy protein and whole oat soluble fiber related FDA health claims, those skilled in the art will appreciate that the particulate nutrient delivery system of the present invention may be used to make bakery products to meet other health claims approved by the FDA without sacrificing baked product quality. The present invention enables the skilled artisan to tailor a bakery product formulation to deliver the high levels of nutrients required by the FDA to make health claims regarding the product, while at the same time meeting the consumer preference for consistently high quality commercial bakery products.

### EXAMPLE III

### Corn Grit-Containing Products

Although the previous embodiments of the present invention have demonstrated products which meet an FDA health claim requirement, in another embodiment of the present invention, particulates can be added to a dough formula to result in products that meet consumer expectations of organoleptic properties of the baked product. For example, a dough containing a high level of corn grits was prepared in accordance with the present invention, and resulted in a baked product with a desirable specific volume in addition to providing a baked product with a high level of corn grits and the associated flavor and textural attributes. The corn grit-containing bread products appeal to consumers seeking an alternative to heavier cornmeal based corn muffins or cake-like corn breads.

Six formulas were used, each with a different level of corn flour and corn grits. All ingredient levels are shown as percent by weight (wt-%), unless indicated otherwise.

TABLE 8
Corn Ingredient Combinations

| | Formula | Formula | Formula | Formula | Formula | Formula |
|---|---|---|---|---|---|---|
| Ingredient | 1 | 2 | 3 | 4 | 5 | 6 |
| Corn Flour¹ | 50.00 | 36.84 | 25.00 | 20.00 | 13.16 | 0.00 |
| Corn Grits² | 0.00 | 13.16 | 25.00 | 30.00 | 36.84 | 50.00 |
| Ratio of Corn | 1:0 | 2.8:1 | 1:1 | 1:1.5 | 1:2.8 | 0:1 |
| Flour:Corn | | | | | | |
| Grits | | | | | | |
| Percent Ratio | 100:0 | 76:24 | 50:50 | 40:60 | 24:76 | |

¹Cargill Dry Corn Ingredients' Yellow Corn Flour, Cargill, Inc., MN
²Cargill Dry Corn Ingredients' Yellow Corn Grits 01850-00, Cargill, Inc., MN

To make the dough, the corn ingredients were combined with the following base formula, along with 50 grams of fresh yeast and 703.22 grams of 40° F. water to result in a dough with a moisture content of about 33.1 wt-%.

TABLE 9
Base Formula (1746 g base formula)

| Ingredient | Weight Percent |
|---|---|
| Flour | 31.81 |
| Corn Ingredient (see Table 8) | 50.00 |
| Vital Wheat Gluten | 8.59 |
| Shortening | 2.43 |
| Sugar | 4.07 |
| Salt | 2.03 |
| Dough conditioner | 1.15 |

The ingredients were mixed in a Hobart C-100 mixer for 1 minute on the low setting, then 10 minutes on the medium setting. 220 g portions of the dough were made and rounded, then allowed to rest for 10 minutes. The dough of Formula 1 which contained only corn flour as the corn ingredient was the Control dough formula in this example and was noticeably quite stiff and difficult to handle compared to the corn grit-containing formulas. It is believed that this is due to the water absorption properties of corn flour, which absorbs more water and becomes more integrated into the dough than corn grits.

To simulate commercial breadmaking, a pre-weighed, rounded dough portion was sheeted to 6 mm in thickness, rolled into a cylinder, and then placed in a pup loaf pan and proofed to 1 inch above the top of the pan in a proof box at 105° F. and 95% relative humidity. The dough was then baked in the pan for 16 minutes at 400° F.

The specific volume of bread made from each formula was measured using a conventional rapeseed displacement method. The results are summarized in Table 10.

TABLE 10
Average Specific Volume

| Formula | Average Specific Volume (cc/g) |
|---|---|
| 1 | 2.92 |
| 2 | 3.66 |
| 3 | 3.80 |
| 4 | 3.80 |
| 5 | 4.60 |
| 6 | 4.59 |

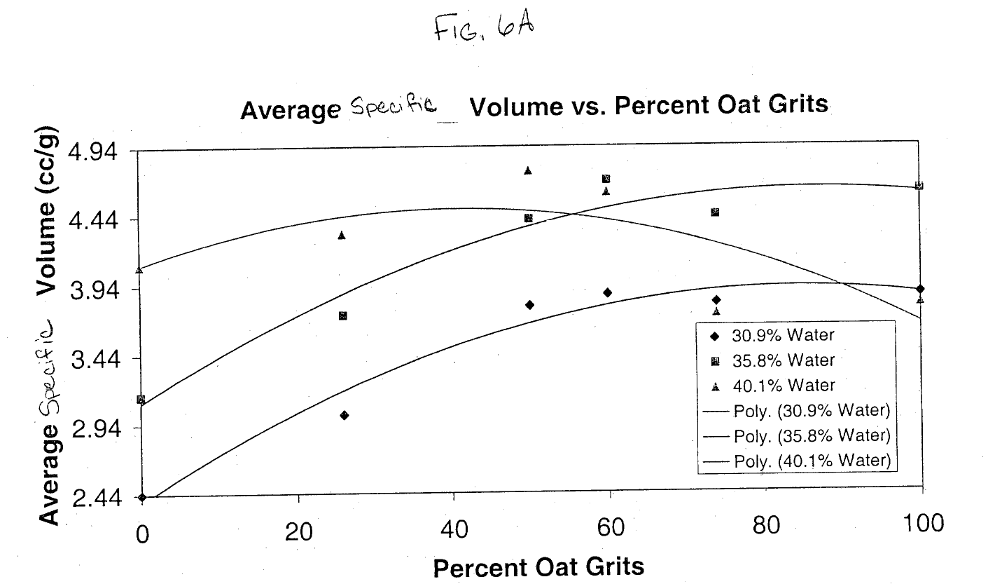

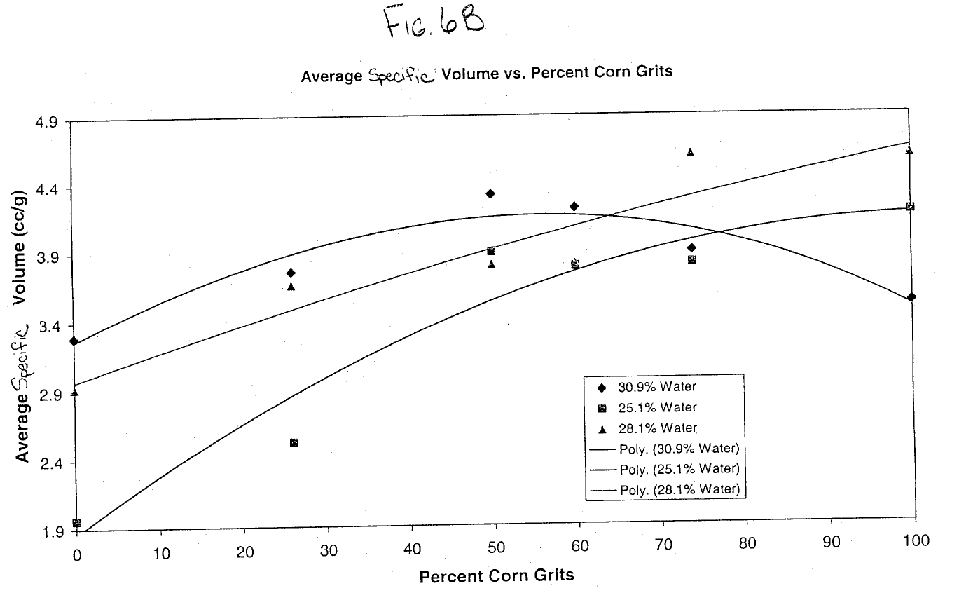

As can be seen from Table 10, there is a significant increase in specific volume compared to the control product as the corn grit concentration was increased in the dough. In this embodiment, the specific volume of the baked products increased as the corn grit concentration increased. The products made in accordance with the present invention had specific volumes ranging from about 1.3 to about 1.6 times the specific volume of the control product. FIGS. 4A-C show side, front and cross-sectional views of bread products made from Formulas 1-6 to demonstrate the improvement of specific volume as corn grits are added to the formula.

This embodiment of the present invention demonstrates the unexpected finding that by optimizing particulate characteristics, large amounts of particulates, up to 50 wt-% on a dry basis, can be added to a dough formulation without adverse effects on the specific volume of the corresponding baked product. In this embodiment, the corn grit particulate size was selected to preferably be about 1000 μm in diameter, but can range from 500μm to about 2500 μm.

### EXAMPLE IV

### Coffee Grit-Containing Bakery Product

In another embodiment of the present invention in which a consumer need or preference is met by the product made with the particulate system, a coffee grit-containing bread was prepared. Unexpectedly, the resulting product had desirable specific volumes, and delivered high levels not only of coffee flavor and color, but also desirable levels of coffee aroma and caffeine.

Six formulas were used, each with a different level of coffee flour and coffee grits. All ingredient levels are shown as percent by weight (wt-%), unless indicated otherwise.

TABLE 11
Coffee Ingredient Combinations

| | Formula | Formula | Formula | Formula | Formula | Formula |
|---|---|---|---|---|---|---|
| Ingredient | 1 | 2 | 3 | 4 | 5 | 6 |
| Coffee Flour¹ | 20.00 | 14.74 | 10.00 | 8.00 | 5.26 | 0.00 |
| Coffee Grits² | 0.00 | 5.26 | 10.00 | 12.00 | 14.74 | 20.00 |
| Ratio of Coffee | 1:0 | 2.8:1 | 1:1 | 1:1.5 | 1:2.8 | 0:1 |
| Flour:Coffee | | | | | | |
| Grits | | | | | | |
| Percent Ratio | 100:0 | 76:24 | 50:50 | 40:60 | 24:76 | 0:100 |

¹Espresso grind, average particle size of about 324 μm.
²French press grind, average particle size of about 862 μm.

To make the dough, the coffee ingredients were combined with the following base formula, along with about 72 grams of fresh yeast and 805 grams of 40° F. water to result in a dough with a moisture content of about 35.5 wt-%

TABLE 12
Base Formula (1723 g base formula)

| Ingredient | Weight Percent |
|---|---|
| Flour | 52.93 |
| Coffee Ingredient (see Table 11) | 20.00 |
| Vital Wheat Gluten | 14.14 |
| Shortening | 1.00 |
| Sugar | 6.70 |
| Salt | 3.35 |
| Dough Conditioner | 1.88 |

The ingredients were mixed in a Hobart C-100 mixer for 1 minute on the low setting, then 10 minutes on the medium setting. 220 g portions of the dough were made and rounded, then allowed to rest for 10 minutes. The dough of Formula 1 which contained only coffee flour as the coffee ingredient was the control dough formula in this example, and was noticeably quite stiff and difficult to handle compared to the coffee grit-containing formulas. It is believed that this is due to the water absorption properties of coffee flour, which absorbs more water and becomes more integrated into the dough than coffee grits.

To simulate commercial breadmaking, a pre-weighed, rounded dough portion was sheeted to 4 mm in thickness, rolled into a cylinder, and then placed in a pup loaf pan and proofed to 1 inch above the top of the pan in a proof box at 105° F. and 95% relative humidity. The dough was then baked in the pan for 16 minutes at 400° F.

The specific volume of bread made from each formula was measured using a conventional rapeseed displacement method. The results are summarized in Table 13.

TABLE 13
Average Specific Volume

| Formula | Average Specific Volume (cc/g) |
|---|---|
| 1 | 4.44 |
| 2 | 4.96 |
| 3 | 4.98 |
| 4 | 4.60 |
| 5 | 5.28 |
| 6 | 4.88 |

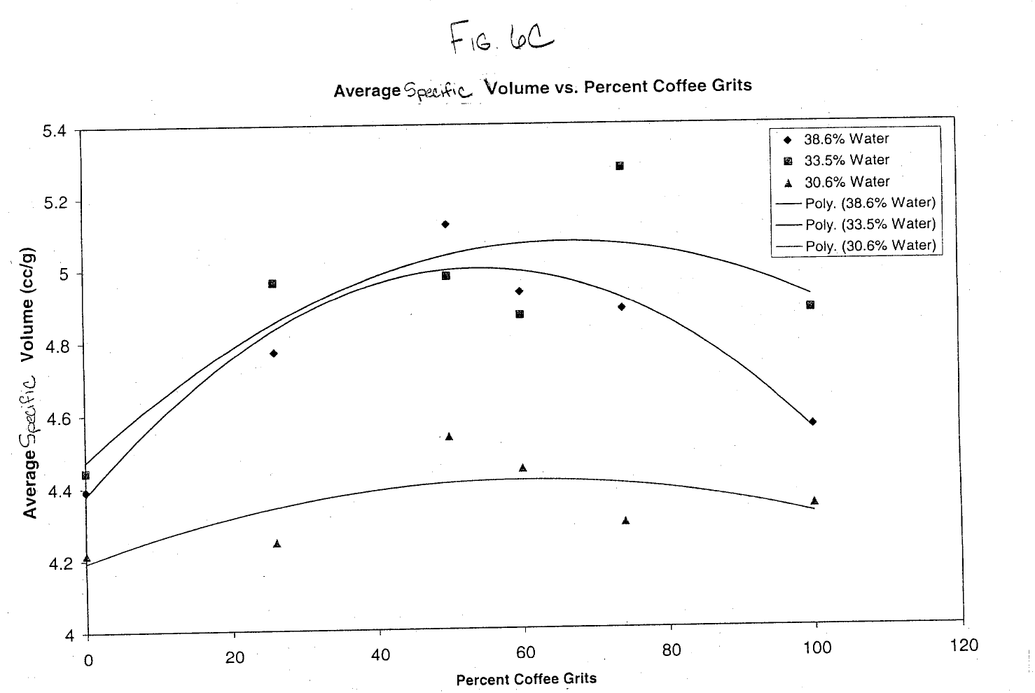

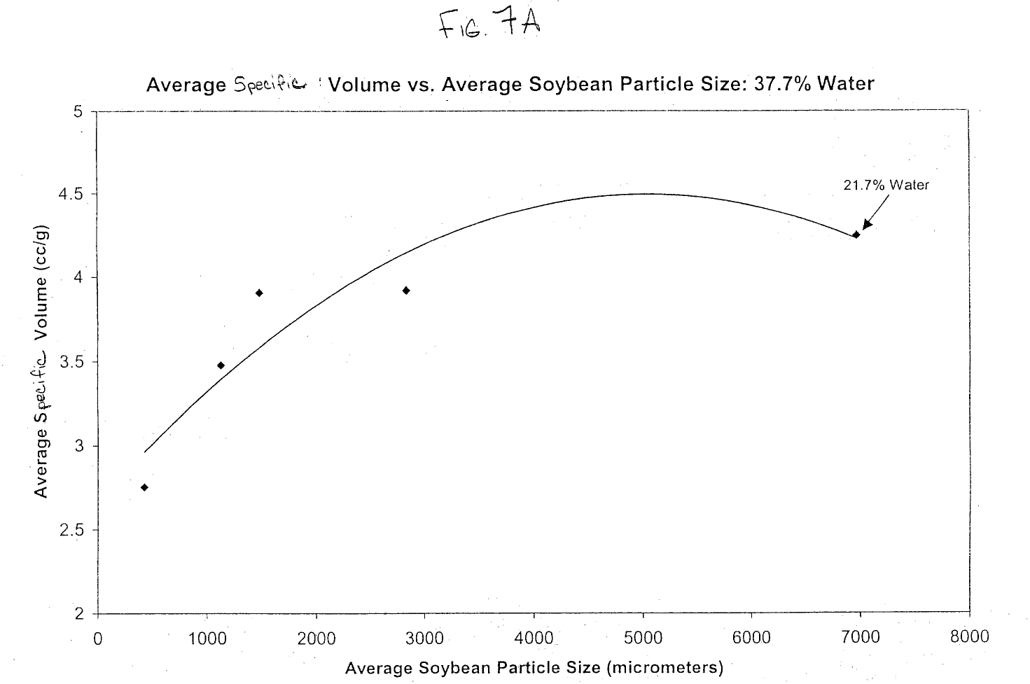

As can be seen from Table 13, there is a significant increase in specific volume compared to the control product as the coffee grit concentration was increased in the dough. In this embodiment, the specific volume of the baked products increased as the coffee grit concentration increased, up to about 15 wt-% of the base formula. The products made in accordance with the present invention had specific volumes ranging from about 1.0 to about 1.2 times the specific volume of the control product. FIGS. 5A-C show side, front and cross-sectional views of bread products made from Formulas 1-6 to demonstrate the improvement of specific volume as coffee grits are added to the formula.

The products made in this example contained approximately 67.6 mg of caffeine per 50 g serving. A cup of regular coffee has between about 60 to 100 mg of caffeine, so the product of the present invention delivered caffeine at a level similar to that of a cup of coffee. This type of coffee bread product may be used to deliver prescribed doses of caffeine for various medical treatments, such as for the treatment of migraine headaches or to stimulate the body's metabolic rate.

This embodiment of the present invention demonstrates the unexpected finding that by optimizing particulate characteristics, ingredients that are not typically found in baked goods, such as coffee, can be added to a dough formulation without adverse effects on the specific volume of the corresponding baked product. Other ingredients that may be added to a dough by using the particulate ingredient delivery system of the present invention include other grains, herbs, spices, chocolate, fruits, vegetables, nuts, seeds, wild rice, candy, meats, cheeses, vitamins, minerals, antioxidants, medications/drugs, dietary supplements, beta glucans, arabinoxylans, inulin, encapsulated liquids or gels, and the like, to meet specific consumer preferences. In this embodiment, the coffee grit particulate size was selected to preferably be about 860 μm in diameter, but can range from 800 μm to 3000 μm.

Rheological Properties of Particulate-Containing Doughs

Although the foregoing embodiments have been used to demonstrate the present invention, those skilled in the art will understand that many other variables come into play in the breadmaking process, such as crop-year related changes in flour protein content and quality, manufacturing equipment design and line setup, environmental conditions such as temperature and relative humidity o f the manufacturing site, etc. Those skilled in the art appreciate that all dough formulations need to be optimized to some degree to take into account the effects of these variables in order to make a processable dough.

One common way in which dough formulations can be adjusted is by optimizing the water content of the dough to make a suitably processable dough, which bakes into a product having a specific volume in the desired range.

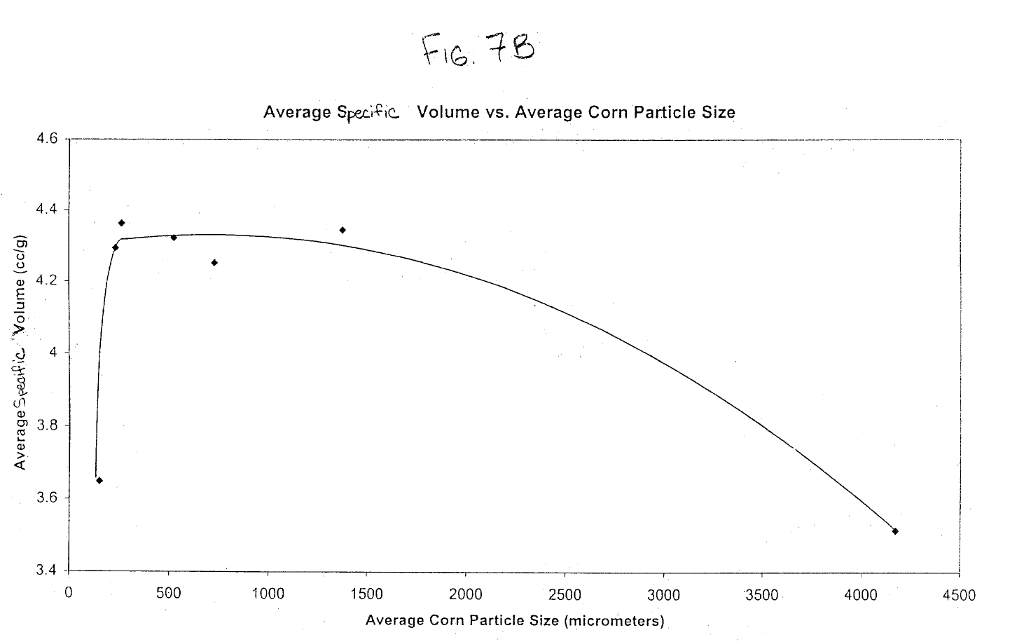

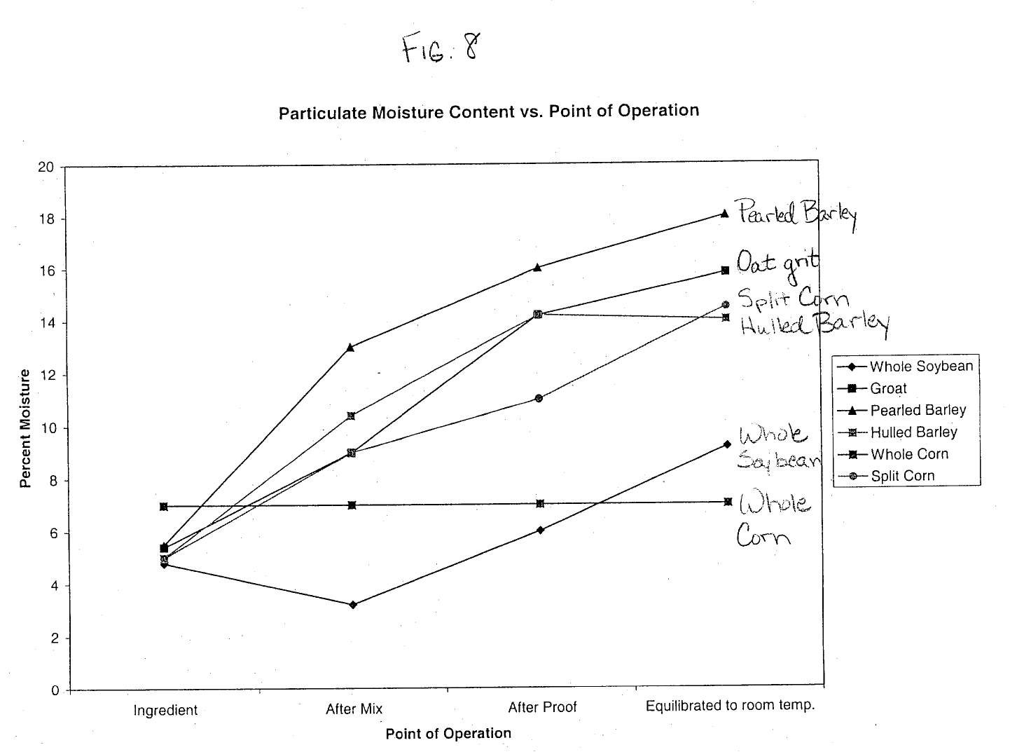

To demonstrate this optimization for the particulate-containing doughs made in accordance with the present invention, several dough formulas were made by reducing or adding water to the dough formula in 200 g increments. FIGS. 6A-C show the impact that changing dough moisture had on the specific volume of the baked product for oat grit, corn grit, and coffee grit containing products, respectively.

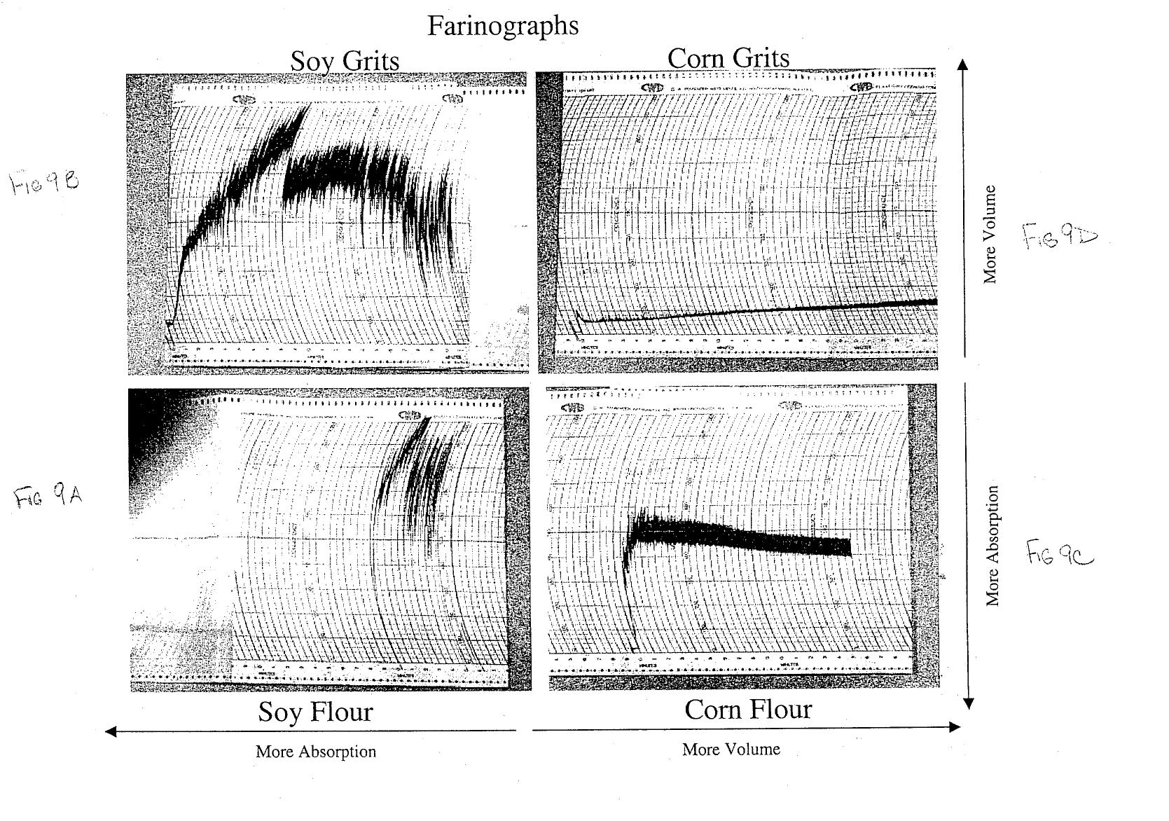

Another variable that can be optimized in accordance with the present invention is particle size. Depending on the starting material, the size of the particulate can have a significant impact on the specific volume of the final product. FIGS. 7A and B demonstrate the effects that particle size can have on specific volume for soybean particles and corn particles, respectively. As can be seen, there are ranges in particle size for each type of particle, above 100 μm, in which the desired specific volumes can be achieved.

In FIG. 7A, the water content of the dough was reduced for very large soybean particles. The reduction in the water content was made to account for the fact that as particulate size increases, the overall surface area of the particulate decreases. The decrease in surface area causes particulates, like large soybeans particles, to absorb less water during the breadmaking process. In addition, the surface material of large soybean particles is primarily seed coat, rather than the interior cotyledon material, which may decrease the rate of water absorption from the dough to the soybean particle.

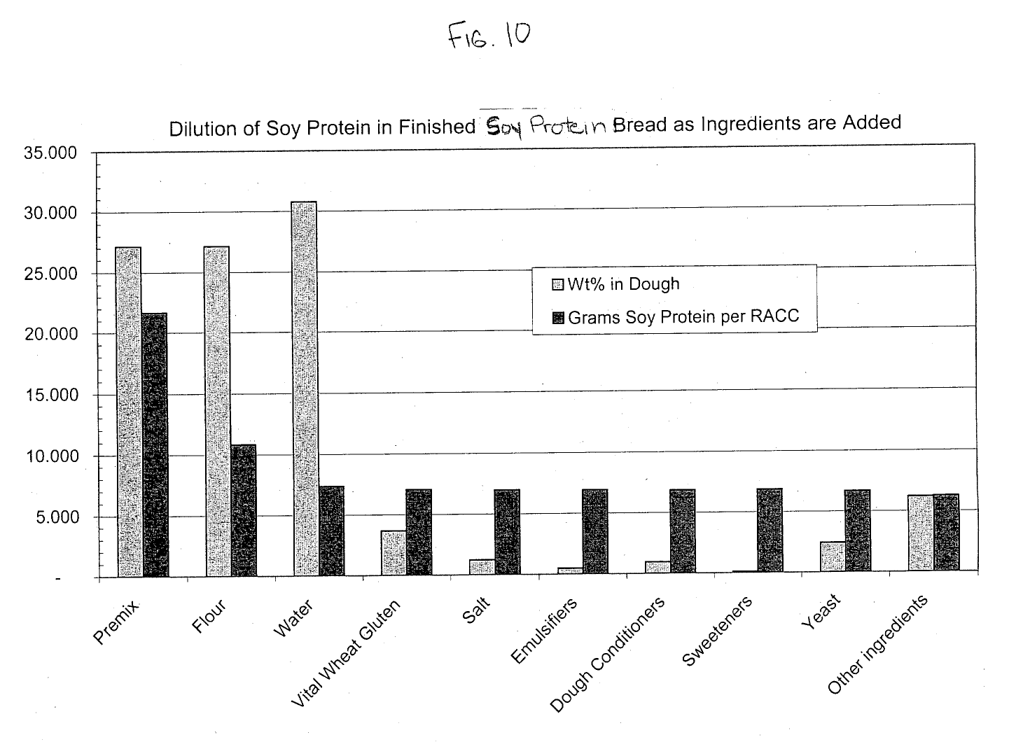

These variations in specific volumes represent the different interactions the particulates have with the dough ingredients based on the type and size of the particulate. FIG. 8 shows examples of particulate moisture interactions of some particulates. As can be seen, the range of water interactions varies widely among particulates and particulate sizes, such as whole corn, which hardly interacts with water at all, or pearled barley, which absorbs a significant amount of water during processing. These variations in water interactions are representative of how the particulate interacts with the other dough ingredients.

To understand the variations in water and dough interactions among various particulates, a farinograph analysis may be conducted to observe water absorption and dough development during mixing. Those skilled in the art will recognize that a farinograph analysis may be conducted to optimize dough mixing conditions, by using the farinograph of a suitable dough as the standard to be achieved for a given particulate. As can be seen in FIGS. 9A-D, different particulate materials have different effects on water absorption as measured by a farinograph.

To obtain the farinographs shown in FIGS. 9A-D, the following procedure was used. For a 480 g batch, about 38.6 wt-% flour, 27.25 wt-% corn or soy flour or particles, and 4 wt-% vital wheat gluten were placed in a 300 g farinograph bowl having a temperature of 30° C. These ingredients were dry blended for 1 minute on speed 1 (63 rpm), after which about 145 mL of water were added. For the soy particulate curve, a 1 kg weight was placed on the arm of the farinograph at 10 minutes, adjusting the curve by 250 Brabender units.

The farinographs in FIGS. 9A-D demonstrate that small hygroscopic particles, such as soy flour, radically raise water absorption, so high amounts of water must be added to yield optimal rheological properties in the dough. Soy grits, however, have a much smaller effect on absorption and less water is required to optimize the Theological properties of the dough. Examples of corn flour and corn grits are also shown to demonstrate the effects of these less hygroscopic corn ingredients on the rheological properties of the dough.

Despite this variability, the particulate ingredient delivery system of the present invention is capable of accommodating the dough interaction characteristics of a given particulate based on its type and size, to produce a baked product within the range of desired specific volumes and textures.

Providing Particulate Nutrients or Ingredients as Pre-Mixes

In the embodiments described above, the particulate ingredient has been described as being added directly to the remaining dough ingredients alone or in combination with the same ingredient in flour form, for example, soy grits and soy flour. In another embodiment of the invention, the particulate ingredient can be provided as a pre-mix containing the particulates, optionally the same ingredient in flour form, and other pre-mix additives, with the pre-mix containing these ingredients in an amount sufficient to provide the desired ingredient level in the final product. If the pre-mix contains the particulate ingredient and the same ingredient in flour form, preferably the particulate ingredient and the ingredient in flour form are present in pre-mix in the ratios described in the Examples. The additives may include any functional ingredient to facilitate the handling of the pre-mix, or to meet a certain manufacturing or consumer need, such as a dough conditioner or a flavoring agent.

In one preferred embodiment of the pre-mix, the pre-mix includes the particulate ingredient, the same ingredient in flour form, a fat, and a starch. In a more preferred embodiment of the pre-mix, the particulate ingredient is present in an amount ranging from about 24 wt-% to 93 wt-% by weight of the pre-mix. The same ingredient in flour form is preferably present in an amount ranging from about 0-68 wt-%. One example of a pre-mix formula in accordance with the present invention is described below.

TABLE 14
Soy Grit Pre-Mix Formula

| Ingredient | Weight Percent of Pre-mix |
|---|---|
| Soy Grits | 54.78 |
| Soy Flour | 37.36 |
| Soybean Oil | 4.5 |
| Starch | 3.36 |

When 50 pounds of this pre-mix are combined with 50 pounds of flour and further processed, the resulting baked product will have the soy protein level required to meet the FDA soy protein health claim requirement.

Another example of a pre-mix formula in accordance with the present invention is shown in Table 15.

TABLE 15
Oat Grit Pre-Mix Formula

| Ingredient | Weight Percent of Pre-mix |
|---|---|
| Whole Oat Grits | 49.41 |
| Whole Oat Flour | 32.94 |
| Vital Wheat Gluten | 13.76 |
| Soybean Oil | 3.89 |

When 100 pounds of this pre-mix are combined with 50 pounds of flour and further processed, the resulting baked product will have the whole oat soluble fiber level required to meet the FDA whole oat soluble fiber health claim requirement.

In addition to providing the final bakery product with the desired ingredient level, such as a desired soy protein or whole oat soluble fiber level, the pre-mix may also include other ingredients designed to deliver specific bakery product attributes, such as starch, fiber, carbohydrate, protein, fat, lipids, and the like. For example, the pre-mix may include a portion of the other formula ingredients, such as flour, gluten, emulsifier, dough conditioner, fat, etc. The pre-mix may include flavoring agents, such as herbs, spices, or other flavoring ingredients, at levels sufficient to provide the desired flavor attributes in the final product.

Although the pre-mix may be used to provide numerous other ingredients to the dough, it is important to maintain the level of the particulate ingredient being provided by the pre-mix at a level sufficient to result in the desired ingredient level and quality in the final product. The following analysis demonstrates this point for a soy grit-containing formula.

### EXAMPLE V

### Added Ingredients

A soy grit-containing dough was made according to the following formula:

TABLE 16
Soy Protein Concentration Analysis

| | Dry Weight % | |
|---|---|---|
| Ingredient | (2268 g base formula) | Weight % in Dough |
| Flour | 40.58 | 27.10 |
| Pre-mix (see Table 14) | 40.58 | 27.10 |
| Moisture | — | 30.70 |
| Vital Wheat Gluten | 5.47 | 3.7 |
| Yeast | — | 2.4 |
| Salt | 1.82 | 1.2 |
| Dough conditioners | 1.42 | 0.95 |
| Emulsifiers | 0.71 | 0.47 |
| Sweeteners | 0.15 | 0.10 |
| Other ingredients | 9.26 | 6.2 |

To the dry ingredients, 81.61 g of yeast were added along with 1042.4 g of water to result in a dough having the composition shown in Table 16. The dough was processed as described for the previous examples.

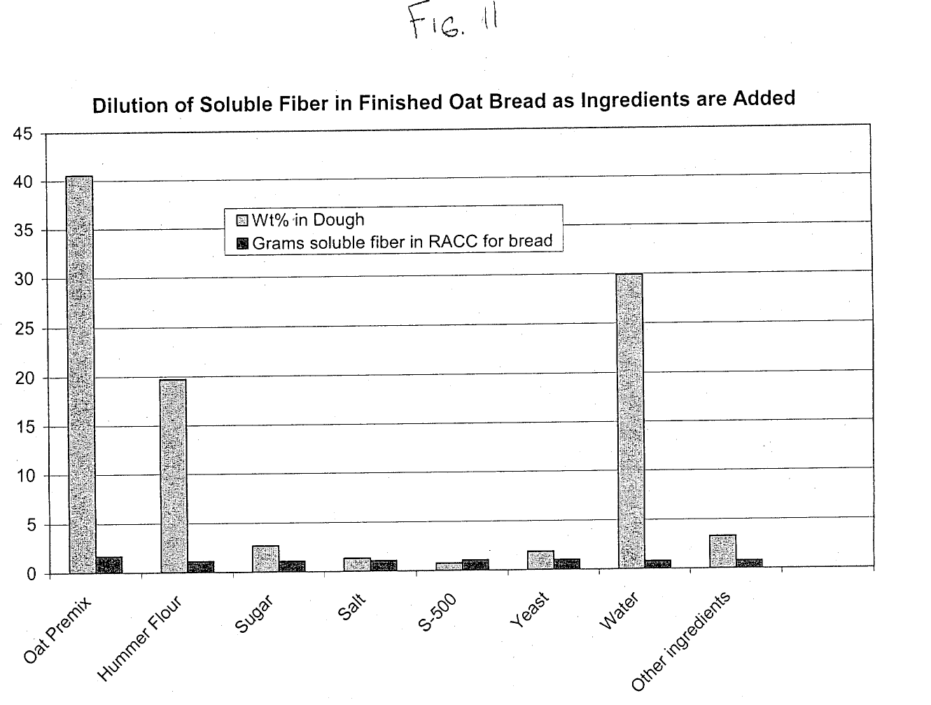

Starting with the pre-mix, as each of the ingredients was added to the formula, the soy protein content of the formula was calculated. It was found that up to about 6% of additional ingredients could be added to the total formula while maintaining the soy protein level needed to meet the FDA health claim requirement. Preferably, up to about 5% of additional ingredients can be added to the total formula while maintaining the desired soy protein content of 6.25 g per 50 grams of product. FIG. 10 shows the level of soy protein available as the ingredients are added to the dough formula.

These additional ingredients may be included with the pre-mix, or may be added directly to the other dough ingredients during mixing.

If the particulate ingredient is provided in the form of a pre-mix, it is preferably packaged in an amount suitable for commercial baking operations. In the embodiment described above, the pre-mix was combined with the flour in a 1:1 ratio. On a commercial scale, for example, this would enable the manufacturer to combine a 50-lb bag of pre-mix with a standard 50-lb bag of flour to result in a blend that provides the desired level of particulate nutrient to the final product.

An oat grit-containing dough was made according to the following formula:

TABLE 17
Oat Soluble Fiber Concentration Analysis

| | Dry Weight % | |
|---|---|---|
| Ingredient | (2268 g base formula) | Weight % in Dough |
| Pre-mix (see Table 15) | 59.45 | 40.57 |
| Moisture | — | 29.89 |
| Flour | 28.87 | 19.70 |
| Sugar | 3.87 | 2.64 |
| Yeast | — | 1.86 |
| Salt | 1.94 | 1.32 |
| Dough conditioners | 1.09 | 0.75 |
| Other ingredients | 4.78 | 3.26 |

To the dry ingredients, 61.82 g of yeast were added along with 993.4 g of water to result in a dough having the composition shown in Table 17. The dough was processed as described for the previous examples.

Starting with the pre-mix, as each of the ingredients was added to the formula, the whole oat soluble fiber content of the formula was calculated. It was found that up to about 4.78% of additional ingredients could be added to the total formula while maintaining the whole oat soluble fiber level needed to meet the FDA health claim requirement. Preferably, up to about 3% of additional ingredients can be added to the total formula while maintaining the desired oat soluble fiber content of 0.75 g per 50 grams of product. FIG. 10 shows the level of oat soluble fiber available as the ingredients are added to the dough formula.

These additional ingredients may be included with the pre-mix, or may be added directly to the other dough ingredients during mixing.

If the particulate ingredient is provided in the form of a pre-mix, it is preferably packaged in an amount suitable for commercial baking operations. In the embodiment described above for oat grits, the pre-mix was combined with the flour in a 2:1 ratio. On a commercial scale, for example, this would enable the manufacturer to combine a 100-lb bag of pre-mix with a standard 50-lb bag of flour to result in a blend that provides the desired level of particulate nutrient to the final product.

Sponge-Dough Method

The foregoing examples and embodiments have utilized a “straight-dough” process to make the dough. In other words, all the ingredients are weighed and added to the mixer, and mixed together until the dough has developed its optimal rheological properties.

It has been surprisingly found that a “sponge-dough” process can also be used to make particulate-containing products in accordance with the present invention. In a typical sponge-dough process, the yeast is combined with about two-thirds of the flour and water, and allowed to ferment. Once the sponge has developed, it is combined with the remaining ingredients in a mixer to form the dough, and the dough is then further processed and baked similar to a straight-dough.

When wheat gluten is added to a dough formula, in the sponge-dough process it is preferable to include some or all of the gluten in the sponge to permit the gluten to hydrate. In one embodiment of the present invention, a sponge is made by combining a portion of the yeast, flour and water, and the vital wheat gluten, and allowing the combination to ferment. By allowing the yeast to ferment and generate carbon dioxide, and the gluten to hydrate and begin forming the gluten matrix, when the sponge is combined with the particulates and other remaining dough ingredients, a suitable dough can be made which results in the desired baked product specific volumes. Examples of the sponge-dough process are described below.

### EXAMPLE VI

### Sponge-Dough Process for Particulate-Containing Doughs

A soy grit-containing dough was made according to the following formula:

TABLE 18
Sponge-Dough Formulas

| | Total Formula | |
|---|---|---|
| | Wt- % | |
| | (943 g Base | Wt- % in Sponge |
| Ingredient | Formula) | (376.28 g Dry Basis) |
| Flour | 44.92 | 33.69 |
| Pre-Mix (Table 14) | 44.38 | |
| Vital Wheat Gluten | 5.96 | 5.96 |
| Salt | 1.99 | |
| Emulsifier | 0.79 | |
| Dough Conditioner | 0.79 | |
| Sodium Stearoyl Lactylate | 0.79 | |
| Yeast Food¹ | 0.22 | 0.22 |
| Aspartame | 0.14 | 0.14 |

¹BENCHMATE ™ Yeast Food, Non-Bromated 2332, Fleischmann's Yeast, MO

To make the sponge, the sponge ingredients were combined with about 17 g of yeast and 270.24 g of water. As an example, if the total formula weight is 943 g, the sponge will include about 317.93 g of flour, or 33.96%. The sponge ingredients were mixed in a Hobart C-100 mixer for 1 minute on the low setting, and 2 minutes on the medium setting. The sponge was allowed to ferment for approximately 3 hours.

The remaining dough ingredients were then mixed with the sponge and 13.04 g of yeast and 256.11 g water in the Hobart C-100 mixer for 1 minute at the low setting and 3.5 minutes at the medium setting. The dough was then divided into 200 g portions, and then allowed to rest for 5 minutes. It was then sheeted to a thickness of 6 mm, rolled into a cylinder, and placed in a pan. The dough in the pan was proofed in a proof box at 105° F. and a relative humidity of 95%, until it reached a height of 1 inch above the top of the pan. The dough was then baked at about 400° F. for about 16 minutes. The average specific volume of the baked product resulting from the sponge-dough process in this Example was about 4.59 cc/g.

### EXAMPLE VII

### SSL Sponge-Dough Process for Particulate-Containing Dough

The following formula was used to make a dough using a sponge-dough process.

TABLE 19
SSL-Sponge-Dough Formula

| | Total Formula | |
|---|---|---|
| | (wt- %) | Wt- % of Total Formula in |
| | (940 g Base | Sponge |
| Ingredient | Formula) | (339 g Dry Basis) |
| Flour | 44.84 | 29.06 |
| Premix (Table 14) | 44.56 | |
| Vital Wheat Gluten | 5.98 | 5.98 |
| Salt | 2.00 | |
| Emulsifier | 0.80 | |
| Dough Conditioner | 0.80 | |
| Sodium Stearoyl Lactylate | 0.80 | 0.80 |
| (SSL) | | |
| Yeast Food | 0.22 | 0.22 |

To make the sponge, the sponge ingredients were combined with 8.4 g of yeast and 254.21 g of water to result in a sponge with a moisture content of about 45%. As an example, if the total formula weight is 940 g, the sponge would be made from about 273 g of flour (29.06%). The sponge ingredients were mixed in a Hobart C-100 mixer for 1 minute on the low setting, and 2 minutes on the medium setting.

The sponge was allowed to ferment for about 3 hours, after which the remaining ingredients were added along with 25.35 g of yeast and 272.14 g of water to produce a dough. The dough was mixed for 1 minute at the low setting, and 3 minutes on the medium setting, and reached a temperature of 80° F.

The dough was divided into 200 g portions, rounded and allowed to rest for 10 minutes. Then each pre-weighed, rounded dough portion was sheeted to a thickness of 6 mm, rolled into a cylinder, and placed in a pan. The dough in the pan was proofed in a proof box at 105° F. at a relative humidity of 95%, until the dough reached a height of about 1 inch above the top of the pan. The proofed dough was then baked at 400° F. for 16 minutes to make the baked product. The average specific volume of the product made from the SSL-sponge-dough in this Example was 4.83 cc/g.

In this Example, it was found that adding the dough conditioner, sodium stearoyl lactylate (SSL), to the sponge, rather that at the dough stage, permitted the SSL to act on the gluten more effectively than if the gluten matrix is allowed to develop before the SSL is added. By adding the SSL to the sponge, therefore, the SSL can interact with the gluten as the gluten matrix is forming, providing a better structure at the dough stage and an improved specific volume upon baking.

It is believed that by using this SSL-sponge-dough method, potentially negative effects of the particulate on the dough structure can be further ameliorated. This may permit the use of smaller particulate sizes without the concomitant adverse effect on the dough structure and baked product specific volume.

The ability to successfully use a sponge-dough process in the particulate ingredient delivery system of the present invention is surprising because it was believed that in doughs containing significant amounts of non-glutenaceous materials, the gluten matrix and cell structure developed in the sponge would be significantly destroyed by the addition of the non-glutenaceous materials, particularly if in particulate form, when the dough is mixed. As an example, in a dough formula containing sufficient soy flour to meet the FDA health claim requirement on soy protein, using the sponge-dough method, even with gluten in the sponge, resulted in a dough that was very difficult to process, and in a baked product with unacceptably low specific volumes and correspondingly poor textures.

By using the particulate ingredient delivery system of the present invention, however, the sponge-dough process was surprisingly successful, and resulted in suitable baked products having desirable specific volumes and textures.

Soy Protein Isolate

There have been attempts made to increase the soy protein content of a bakery product by adding soy protein isolate to the dough formula. Soy protein isolate is obtained by concentrating the protein fraction of soybeans, to provide a soy protein level of 90%, compared to a soy protein level of 50% in soy grits and soy flour. To date, however, soy protein isolate-containing bakery products have demonstrated extremely poor specific volumes that are unacceptable for commercial products.

It has been surprisingly discovered, however, that by using the particulate nutrient delivery system of the present invention in conjunction with soy protein isolate, baked products having very high soy protein levels with desirable specific volumes can be made. Adding soy grits to a soy protein isolate-containing bread dough formula resulted in a baked product having an average specific volume comparable to that of a dough formula containing the same level of soy protein and soy grits using soy flour rather than soy protein isolate. An example of this embodiment of the present invention is described below.

### EXAMPLE VIII

### Soy Protein Isolate (SPI) and Soy Grit-Containing Bread

Four dough products with soy protein levels meeting the FDA soy protein health claim requirement were made in accordance with the following formulas:

TABLE 20
Soy Protein Isolate Base Formulas (2268 g base formula)

| | | 2 | 3 | |
|---|---|---|---|---|
| | 1 | SPI + Soy | SPI + | 4 |
| Ingredient | SPI | Flour | Grits | Grits + Soy Flour |
| Flour | 59.53 | 54.65 | 48.40 | 43.45 |
| Soy Flour | — | 16.8 | — | 16.80 |
| Soy Protein Isolate¹ | 23.40 | 14.00 | 9.33 | — |
| Lecithin² | 2.52 | — | 2.52 | — |
| Soy Grits | — | — | 25.20 | 25.20 |
| Vital Wheat Gluten | 6.00 | 6.00 | 6.00 | 6.00 |
| Soybean Oil | 4.08 | 2.50 | 4.08 | 2.50 |
| Cornstarch | 1.50 | 1.50 | 1.50 | 1.50 |
| Salt | 2.00 | 2.00 | 2.00 | 2.00 |
| Emulsifier | 0.80 | 0.80 | 0.80 | 0.80 |
| Dough Conditioner | 0.80 | 0.80 | 0.80 | 0.80 |
| Sodium Stearoyl Lactylate | 0.80 | 0.80 | 0.80 | 0.80 |
| Aspartame | 0.15 | 0.15 | 0.15 | 0.15 |

¹Cargill Prolisse ™ Soybean Isolate, Cargill, Inc., MN
²Central Soya Centrol ™ 3F-UB Lecithin, Central Soya, IN

Each formula was combined with 90 g of yeast. To Formulas 1 and 2, about 1575 g of water were added. To Formula 3, about 1475 g of water were added, and about 1275 g of water were added to Formula 4. The ingredients were mixed in a Hobart C-100 mixer for 1 minute on the low setting and 10 minutes on the medium setting. The resulting dough was scaled into 200 g portions and allowed to rest for 10 minutes. Then each dough portion was sheeted to a thickness of 6 mm, rolled into a cylinder, and placed in a pan. The dough was proofed in a proof box at 105° F. and a relative humidity of 95% until the dough reached a height of 1 inch above the top of the pan. The proofed dough was then baked in the pan for 16 minutes at 400° F.

The average specific volume was measured for each baked product using a conventional rapeseed displacement method. The results are shown in Table 21.

TABLE 21
Average Specific Volume

| Formula | Average Specific Volume (cc/g) |
|---|---|
| 1 | <2.75 |
| 2 | <2.75 |
| 3 | 3.5 |
| 4 | 3.8 |

As seen from the specific volume results, the use of soy grit particulates in combination with soy protein isolate gave an unexpected increase in specific volume while still maintaining the soy protein level required to make the FDA health claim. In this embodiment, the use of soy protein isolate and soy grits instead of soy flour provided a specific volume of about 1.3 times the specific volume of the product made with soy protein isolate and soy flour, or with soy protein isolate as the sole source of soy protein. From a commercial standpoint, the SPI-containing bakery product containing soy grits had an acceptable, and even highly desirable specific volume, as compared to an SPI-only or SPI-soy flour containing product, both of which demonstrated commercially unacceptable specific volumes for bakery products.

In certain embodiments of the present invention which include soy protein isolate in combination with soy grit particulates, it is believed that denaturing the soy protein in the soy protein isolate, thereby lessening the effects of the soy protein on the formation and development of the gluten matrix, may even further improve the specific volume and texture of the final product.

Other Products

As described above, the particulate ingredient delivery system of the present invention can be used to make a variety of bakery products. Some examples of bakery products made in accordance with the present invention are described below.

### EXAMPLE IX

### Herb Bread Containing Soy Protein

An herb-containing bread meeting the FDA health claim requirement for soy protein was made according to the following formula:

TABLE 22
Herb Bread Base Formula (2268 g base formula)

| Ingredient | Weight Percent |
|---|---|
| Flour | 42.83 |
| Pre-mix (Table 14) | 44.76 |
| Vital Wheat Gluten | 6.01 |
| Salt | 2.00 |
| Emulsifier | 0.80 |
| Dough Conditioner | 0.80 |
| Sodium Stearoyl Lactylate | 0.80 |
| Pesto¹ | 2.00 |

¹McCormick Pesto Seasoning WRP-00051, McCormick Flavor Division, MD

These ingredients were combined with 90 g of fresh yeast and 1200 g of water to make a dough. The ingredients were mixed in a Hobart C-100 mixer for 1 minute at the low setting, and 10 minutes at the medium setting. The dough temperature reached 80° F. The dough was divided into 540 g portions, shaped, and allowed to rest for 10 minutes. Each pre-weighed, shaped dough portion was sheeted to a thickness of 6 mm, rolled into a cylinder, and placed in a pan. The dough was then proofed in the pan in a proof box at 105° F. and a relative humidity of 95% until the dough reached a height of 1¼ inches above the top of the pan. The proofed dough was then baked at 400° F. for 23 minutes.

The baked herb bread had a soy protein level of at least 6.25 g per 50 g serving. The specific volume of the baked herb bread was measured using a conventional rapeseed displacement method. The average specific volume of the baked product was similar to that of the product made from Formula 4 of Example 1, or about 3.9 cc/g, and the product had a desirable texture, flavor and eating quality.

### EXAMPLE X

### Cinnamon Bread Containing Soy Protein

A cinnamon bread meeting the FDA health claim requirement for soy protein was made according to the following formula:

TABLE 23
Cinnamon Bread Base Formula (2268 g base formula)

| Ingredient | Weight Percent |
|---|---|
| Flour | 43.96 |
| Pre-mix (Table 14) | 44.76 |
| Vital Wheat Gluten | 6.01 |
| Salt | 2.00 |
| Emulsifier | 0.80 |
| Dough Conditioner | 0.80 |
| Sodium Stearoyl Lactylate | 0.80 |
| Sucralose | 0.09 |
| Cinnamon¹ | 0.78 |

¹McCormick Ground Cinnamon, McCormick & Co., Inc., MD

These ingredients were combined with 90 g of fresh yeast and 1200 g of water to make a dough. The ingredients were mixed in Hobart C-100 mixer for 1 minute on the low setting, then for 10 minutes on the medium setting. The dough was scaled into 540 g portions, shaped, and then allowed to rest for 10 minutes. The dough portions were then sheeted to a thickness of 6 mm. 18 g of a 2:1 sugar:cinnamon mixture was spread onto the upper surface of the sheeted dough portion, and each dough portion was then rolled into a cylinder and placed in a pan. The dough was proofed in the pan in a proof box at 105° F. and a relative humidty of 95% until the dough reached a height of 1¼ inches above the top of the pan. The dough was then baked at 400° F. for 23 minutes.

The cinnamon bread had a soy protein level of at least 6.25 g per 50 g serving. The specific volume of the baked cinnamon bread was measured using a conventional rapeseed displacement method. The average specific volume of the baked product was similar to that of the product made from Formula 4 of Example 1, or about 3.9 cc/g, and the product had a desirable texture, flavor and eating quality.

Although the foregoing embodiments have fully disclosed and enabled the practice of the particulate ingredient delivery system of the present invention, they are not intended to limit the scope of the invention, which is defined by the claims set forth below.

What is claimed is:

1. A ingredient delivery system for bakery products, the system capable of providing a level of an ingredient in a bakery product, said system comprising a particulate ingredient, wherein the bakery product made with the system has a specific volume at least equal to a specific volume of a control bakery product made without the particulate ingredient, but with the same ingredient in flour form and providing the same level of the ingredient in the bakery product.

2. The ingredient delivery system of claim 1, wherein the system is capable of providing a specific volume to the bakery product made with the system that is greater than the specific volume of the control bakery product.

3. The ingredient delivery system of claim 2, wherein the system is capable of providing a specific volume that is at least about 1.2 times greater than the specific volume of the control product.

4. The ingredient delivery system of claim 1, wherein the particulate ingredient is a non-wheat ingredient and the same ingredient in flour form is a non-wheat ingredient.

5. The ingredient delivery system of claim 1, wherein the particulate ingredient has an average particle size greater than about 100 μm in diameter.

6. The ingredient delivery system of claim 1, wherein the same ingredient in flour form has an average particle size of about 100 μm or less in diameter.

7. The ingredient delivery system of claim 4, wherein the particulate ingredient is made from a starting material selected from the group comprising: grains, fruits, vegetables, vitamins, seeds, nuts, candy, minerals, antioxidants, chocolate, wild rice, oilseeds, spices, fiber, legumes, dairy products or ingredients, cheese, calcium, dried meats, bouillon, medications or drugs, dietary or health supplements, beta glucans, arabinoxylans, inulin, peanuts, encapsulated solids, liquids or gels, or combinations thereof.

8. The ingredient delivery system of claim 1, wherein the particulate ingredient is present in the system in an amount ranging from about 24 wt-% to about 93 wt-%.

9. The ingredient delivery system of claim 1, further comprising the same ingredient in flour form.

10. The ingredient delivery system of claim 9, wherein the same ingredient in flour form is present in the system in an amount ranging from about 0 wt-% to 70 wt-%.

11. The ingredient delivery system of claim 1, further comprising a fat component.

12. The ingredient delivery system of claim 11, wherein the fat component is selected from the group comprising: soybean oil, corn oil, canola oil, cottonseed oil, olive oil, tropical oils, vegetable oils, and animal fats.

13. The ingredient delivery system of claim 10, wherein the fat component is present in the system in an amount ranging from about 0 wt-% to about 20 wt-%.

14. The ingredient delivery system of claim 1, further comprising a functional component.

15. The ingredient delivery system of claim 14, wherein the functional component is selected from the group comprising: starch, fiber, carbohydrates, dough conditioners, flavor or seasonings, emulsifiers, fat, lipids, and protein.

16. The ingredient delivery system of claim 1, wherein the level of the ingredient is sufficient to meet an FDA health claim.

17. The ingredient delivery system of claim 16, wherein the particulate ingredient comprises soy protein and the FDA health claim is a soy protein health claim.

18. The ingredient delivery system of claim 17, wherein the level of soy protein provided by the system in the baked product is at least 6.25 g of soy protein per 50 g serving of baked product.

19. The ingredient delivery system of claim 16, wherein the FDA health claim is a whole oat soluble fiber health claim.

20. The ingredient delivery system of claim 16, wherein the level of whole oat soluble fiber provided by the system in the baked product is at least 0.75 g of whole oat soluble fiber per 50 g serving of baked product.

21. The ingredient delivery system of claim 13, wherein the fat component provides less than 3 g of total fat per 50 g serving of the bakery product made with the system, said total fat comprising less than 1 g of saturated fat, and said total fat further comprising less than 20 mg of cholesterol.

22. A bakery product comprising a particulate ingredient delivery system, said system providing a level of the particulate ingredient in the bakery product, wherein the specific volume of the baked product is at least equal to the specific volume of a control bakery product comprising the same level of the ingredient in flour form.

23. The bakery product of claim 22, wherein the bakery product has a specific volume of at least 1.2 times the specific volume of the control product.

24. The bakery product of claim 22, wherein the particulate ingredient is a non-wheat ingredient.

25. The bakery product of claim 22, wherein the level of the particulate ingredient in the bakery product is sufficient to meet an FDA health claim requirement.

26. The bakery product of claim 25, wherein the particulate ingredient comprises soy protein, and the level of soy protein in the bakery product is sufficient to meet an FDA health claim on soy protein content of the bakery product.

27. The bakery product of claim 26, wherein the bakery product comprises at least 6.25 g of soy protein per 50 g serving of the product.

28. The bakery product of claim 25, wherein the particulate ingredient comprises whole oat soluble fiber, and the level of whole oat soluble fiber in the bakery product is sufficient to meet an FDA health claim on whole oat soluble fiber content of the bakery product.

29. The bakery product of claim 28, wherein the bakery product comprises at least 0.75 g of whole oat soluble fiber per 50 g serving of the product.

30. The bakery product of claim 25, wherein the bakery product further comprises a fat component, said fat component comprising less than 3 g of total fat per 50 g serving of the product, said total fat comprising less than 1 g of saturated fat, said total fat further comprising less than 20 mg of cholesterol.

31. The bakery product of claim 25, wherein the bakery product further comprises sodium at a level less than about 480 mg of sodium per 50 g serving of the product.

32. A method of making a particulate-containing dough, comprising the steps of:
providing a particulate ingredient,
combining the particulate ingredient with wheat flour, yeast, salt and water to form a dough having a gluten matrix;
wherein the particulate ingredient does not substantially interfere with the gluten matrix.

33. The method of claim 32, wherein a portion of the wheat flour is combined with a portion of the yeast and a portion of the water, and allowed to develop into a sponge having a gluten matrix, said sponge then being combined with a balance of the wheat flour, yeast, and water, and the particulate ingredient and salt, to form the dough.

34. The method of claim 33, further comprising the step of adding sodium stearoyl lactylate to the sponge.

35. The ingredient delivery system of claim 1, wherein the particulate ingredient comprises soy grit particulates and the same ingredient in flour form comprises soy protein isolate.

36. The ingredient delivery system of claim 35, wherein the soy protein isolate comprises denatured soy protein.
